(19) United States
(12) Patent Application Publication
(10) Pub. No.: US 2014/0333844 A1
(43) Pub. Date: Nov. 13, 2014

(54) LIQUID CRYSTAL DISPLAY APPARATUS AND LIQUID CRYSTAL TELEVISION

(71) Applicant: Keita Ito, Osaka-shi (JP)

(72) Inventor: Keita Ito, Osaka-shi (JP)

(73) Assignee: SHARP KABUSHIKI KAISHA, Osaka-shi, Osaka (JP)

(21) Appl. No.: 14/364,872

(22) PCT Filed: Sep. 14, 2012
(86) PCT No.: PCT/JP2012/073592

§ 371 Date: Jun. 12, 2014

(30) Foreign Application Priority Data
Dec. 13, 2011 (JP) 2011-272666
Jun. 29, 2012 (JP) 2012-147508

(51) Int. Cl. G02F 1/1333; H04N 5/64

(52) U.S. Cl. CPC G02F 1/133308; H04N 5/64; G02F 2001/133314; G02F 2001/13332
USPC 348/794; 349/58

(57) ABSTRACT

A liquid crystal panel module includes a liquid crystal panel, an optical sheet and a light guide plate, which are sequentially laminated from the front side to the back side. A front cabinet is provided with an opening through which a screen of the liquid crystal panel is viewed. The front cabinet includes first ribs formed around the opening on a back face thereof and second ribs formed around the opening on the back face thereof further away from the opening than the first ribs. The first ribs are higher than a total thickness of the liquid crystal panel and the optical sheet, and the second ribs are higher than a total thickness of the liquid crystal panel, the optical sheet and the light guide plate. The liquid crystal panel is housed in an area surrounded by the first ribs. The optical sheet is housed in an area surrounded by the first ribs or the second ribs. The light guide plate is housed in an area surrounded by the second ribs, and a front peripheral edge part thereof abuts a tip end face of the first ribs.

### CROSS-REFERENCE TO RELATED APPLICATIONS

This non-provisional application is a National Stage entry under U.S.C. §371 of International Application No. PCT/JP2012/073592 filed on Sep. 14, 2012, which claims the priorities of Japanese Patent Application No. 2011-272666 filed in Japan on Dec. 13, 2011 and Japanese Patent Application No. 2012-147508 filed in Japan on Jun. 29, 2012. The entire contents of all of the above applications are hereby incorporated by reference.

### FIELD

The present invention relates to a liquid crystal display apparatus including a liquid crystal panel module and to a liquid crystal television.

### BACKGROUND

Each component such as a liquid crystal panel, an optical sheet, a light guide plate, or the like, which are included in an edge light type liquid crystal panel module, is fixed thereto by using frame-shaped bezels.

Japanese Patent Application Laid-Open No. H11-337937 discloses a liquid crystal display apparatus in which the each component is positioned by step-shaped ribs provided on an inner surface of a front cabinet excluding the bezel to reduce the number of components. Each positioned component is pressed at the back and front by screws to be fixed to the front cabinet.

### SUMMARY

However, in the liquid crystal display apparatus disclosed in the Patent Document 1, it is necessary to hold and press an optical sheet which diffuses light by a liquid crystal panel and a light guide plate. In this case, when the held and pressed optical sheet suffers from a deformation, the optical sheet is deformed, and therefore light from a light source is not sufficiently diffused and luminance unevenness in a screen occurs.

In consideration of the above-described circumstances, it is an object of the present invention to provide a liquid crystal display apparatus which prevents a deformation in an optical sheet and a liquid crystal television.

According to the present application, there is provided a liquid crystal display apparatus in which a liquid crystal panel module is disposed between a front cabinet on a front side and a back cabinet on a back side, wherein the liquid crystal panel module includes a liquid crystal panel, an optical sheet which is the same as or wider than the liquid crystal panel, and a light guide plate wider than the optical sheet, which are sequentially laminated from the front side to the back side, and when light from a light source is made incident on the light guide plate and the light is outputted from the light guide plate to the optical sheet, an image is displayed on a screen of the liquid crystal panel viewed through an opening provided in the front cabinet, the liquid crystal display apparatus including: a plurality of first ribs which are provided on a back face of the front cabinet around the opening; and a plurality of second ribs which are provided on the back face of the front cabinet around the opening at a position further away from the opening than the first ribs, wherein the first ribs have a height greater than a total thickness of the liquid crystal panel and the optical sheet, and a tip end face thereof abuts a front peripheral edge part of the light guide plate, the second ribs have a height greater than a total thickness of the liquid crystal panel, the optical sheet and the light guide plate, the liquid crystal panel is configured to be housed in an area surrounded by the first ribs, the optical sheet is configured to be housed in an area surrounded by the first ribs or the second ribs, and the light guide plate is configured to be housed in an area surrounded by the second ribs.

The liquid crystal display apparatus according to the present application includes the liquid crystal panel module disposed between the front cabinet on the front side and the back cabinet on the back side. The liquid crystal panel module includes the liquid crystal panel, the optical sheet, and the light guide plate, which are sequentially laminated from the front side to the back side. The front cabinet is provided with the opening through which the screen of the liquid crystal panel is viewed. The front cabinet includes a plurality of first ribs which are provided on the back face thereof around the opening, and a plurality of second ribs which are provided on the back face of the front cabinet around the opening at a position further away from the opening than the first ribs. The first ribs have a height greater than a total thickness of the liquid crystal panel and the optical sheet, and the second ribs have a height greater than a total thickness of the liquid crystal panel, the optical sheet and the light guide plate. The liquid crystal panel is housed in the area surrounded by the first ribs. The optical sheet is housed in the area surrounded by the first ribs or the second ribs. The light guide plate is housed in the area surrounded by the second ribs, and a front peripheral edge part thereof abuts a tip end face of the first ribs.

A force pressing forward by the light guide plate is applied to the tip end face of the first ribs having a height greater than a total thickness of the liquid crystal panel and the optical sheet, and is not substantially applied to the optical sheet. Therefore, the optical sheet is not bent, and luminance unevenness in an image displayed on the liquid crystal panel is prevented.

The liquid crystal display apparatus according to the present application is characterized in that, the light source is disposed facing one side face of the light guide plate, recesses are provided on an edge part of the light guide plate including an adjoining side face adjacent to the one side face to be fitted with the second ribs, and the second ribs and the recesses are provided at positions corresponding to the near one side face from substantially a center of the adjoining side face, respectively.

In the liquid crystal display apparatus according to the present application, light from the light source disposed facing the one side face of the light guide plate is made incident on the one side face of the light guide plate. The recesses are provided on the edge part of the light guide plate including the adjoining side face adjacent to the one side face thereof facing the light source to be fitted with the second ribs. The second ribs provided on the front cabinet and the recesses provided on the light guide plate are disposed at positions corresponding to the near one side face from substantially a center of the adjoining side face, respectively. The light guide plate is thermally expanded by heat from the light source, and thereby respective parts of the light guide plate are moved. However, the movement of the light guide plate due to the thermal expansion is not generated in the recesses to be fitted with the second ribs. Since the recess and the second rib to be fitted with the recess are disposed at a position corresponding to the nearer one side face from substantially the center of the adjoining side face, in a region of light guide plate of the recess as a border, the region of the nearer one side face is wider than a region of the side opposite thereto. Therefore, an amount of movement of the respective parts of the light guide plate, in the border of the recess, is smaller than that of a part far away from the light source. The brightness of light emitted from the light guide plate to the optical sheet is changed due to a change in a distance between the light source and the one side face of the light guide plate. Since the change in a distance between the light source and the one side face of the light guide plate with increasing temperature is reduced by the second ribs and the recesses, it is possible to reduce brightness unevenness in the image displayed on the liquid crystal panel.

The liquid crystal display apparatus according to the present application is characterized in that, the first and second ribs have a main rib substantially parallel to a peripheral edge of the opening and comb shaped sub ribs which are arranged in parallel to a side wall of the main rib on a side opposite to the opening, respectively.

In the liquid crystal display apparatus according to the present application, the first and second ribs have the main rib and the sub ribs, respectively. The main rib is disposed substantially parallel to the peripheral edge of the opening. The sub ribs are disposed in a comb shape parallel to the side wall of the main rib on a side opposite to the opening.

Thereby, minimal mold sagging occurs at the back face of the front cabinet on which the first and second ribs are provided, and a front face portion opposite thereto. Further, strength of the main rib can be reinforced by the sub ribs.

The liquid crystal display apparatus according to the present application is characterized in that, the first rib and second rib are separated from each other.

In the liquid crystal display apparatus according to the present application, the first rib and second rib are separated from each other.

Conventionally, when the first rib and the second rib are integrally formed by bonding, a volume of a material injected into a mold portion corresponding to the coupled first and second ribs is increased, and sagging is likely to occur in the front face of the front cabinet corresponding to the first and second ribs. However, when the first rib and the second rib are separated from each other in the present application, yet sagging hardly occurs in the front cabinet.

The liquid crystal display apparatus according to the present application is characterized in that, the optical sheet has notches corresponding to the first ribs.

In the liquid crystal display apparatus according to the present application, the optical sheet has the notches formed at a position corresponding to the first ribs.

When the optical sheet is housed in an area surrounded by the second ribs, the notches of the optical sheet are separated from the first ribs so as not to overlap with the first ribs positioned inward of the front cabinet from the second ribs. Thereby, when the optical sheet is incorporated into the liquid crystal display apparatus, the first rib is not disturbed.

According to the present application, there is provided a liquid crystal display apparatus in which a liquid crystal panel module is disposed between a front cabinet on a front side and a back cabinet on a back side, wherein the liquid crystal panel module includes a frame body, a liquid crystal panel narrower than the frame body, an optical sheet which is the same as or wider than the liquid crystal panel, and a light guide plate wider than the optical sheet, which are sequentially laminated from the front side to the back side, and when light from a light source is made incident on the light guide plate and the light is outputted from the light guide plate to the optical sheet, an image is displayed on a screen of the liquid crystal panel viewed through an opening provided in the front cabinet, the liquid crystal display apparatus including: a plurality of first ribs which are provided on a back face of the front cabinet around the opening; a plurality of second ribs which are provided on the back face of the front cabinet around the opening at a position further away from the opening than the first ribs; a plurality of first insertion holes and a plurality of second insertion holes which are penetrated in the frame body so as to have the plurality of the first and second ribs inserted therein; and support parts which are bridged between peripheral edge parts facing each other in a circumferential direction of the frame body in each of the plurality of the first insertion holes, and protrude to a back side so as to support the light guide plate, wherein the first ribs have a height the same as or greater than a total thickness of the frame body, the liquid crystal panel and the optical sheet, the second ribs have a height greater than a total thickness of the frame body, the liquid crystal panel, the optical sheet and the light guide plate, the support part has a height greater than a protrusion height of the first ribs from the first insertion hole, and is configured to abut the light guide plate, the liquid crystal panel is configured to be housed in an area surrounded by the first ribs, the optical sheet is configured to be housed in an area surrounded by the first ribs or the second ribs, and the light guide plate is configured to be housed in an area surrounded by the second ribs.

The liquid crystal display apparatus according to the present application includes the liquid crystal panel module disposed between the front cabinet on the front side and the back cabinet on the back side. The liquid crystal panel module includes the frame body, the liquid crystal panel, the optical sheet, and the light guide plate. The front cabinet is provided with the opening through which the screen of the liquid crystal panel is viewed. The front cabinet includes a plurality of first ribs which are formed on the back face thereof around the opening, a plurality of second ribs which are formed on the back face thereof around the opening at a position further away from the opening than the first ribs. The frame body is provided with a plurality of first insertion holes and a plurality of second insertion holes which have the plurality of the first and the second ribs inserted therein. The support parts for supporting the light guide plate are bridged between the peripheral edge parts facing each other in a circumferential direction of the frame body in the first insertion holes. The support parts protrude to a back side. The first ribs have a height the same as or greater than a total thickness of the frame body, the liquid crystal panel and the optical sheet, and the second ribs have a height greater than a total thickness of the frame body, the liquid crystal panel, the optical sheet and the light guide plate. The support part has a height greater than a protrusion height of the first ribs from the first insertion hole, and is configured to abut the light guide plate. The liquid crystal panel is housed in an area surrounded by the first ribs. The optical sheet is housed in an area surrounded by the first ribs or the second ribs. The light guide plate is housed in an area surrounded by the second ribs, and a front peripheral edge part thereof abuts a tip end face of the support part.

A force pressed forward by the light guide plate is applied to the tip end face of the support part having a height greater than a protrusion height of the first ribs from the first insertion hole, and is not substantially applied to the optical sheet. Therefore, the optical sheet is not bent, and luminance unevenness in an image displayed on the liquid crystal panel is prevented.

The liquid crystal display apparatus according to the present application is characterized in that, the support part includes two protrusion portions protruding from a peripheral edge part of the first insertion hole to a back side thereof, respectively; and a flat portion which is bridged between the two protrusion portions and abuts a front peripheral edge part of the light guide plate.

In the liquid crystal display apparatus according to the present application, the support part includes the two protrusion portions and the flat portion. The two protrusion portions protrude backward from peripheral edge parts of the first insertion hole facing with each other in a circumferential direction of the frame body, respectively. The flat portion is bridged between the two protrusion portions and abuts the front peripheral edge part of the light guide plate. Thereby, the front of the light guide plate is supported by the frame body without abutting the first ribs.

According to the present application, there is provided a liquid crystal television including: the display apparatus according to the above; and a receiving unit which receives television broadcasts, wherein the liquid crystal panel module is configured to display an image relating to television broadcasts received by the receiving unit on the screen of the liquid crystal panel.

The liquid crystal television according to the present application includes the display apparatus according to the above, and the receiving unit which receives television broadcasts.

Thereby, the liquid crystal television displays an image relating to television broadcasts on the liquid crystal panel while luminance unevenness in image is suppressed.

In accordance with the liquid crystal display apparatus and the liquid crystal television according to the present application, it is possible to prevent a deformation in an optical sheet.

The above and further objects and features will more fully be apparent from the following detailed description with accompanying drawings.

### BRIEF DESCRIPTION OF THE DRAWINGS

FIG. 1 is a schematic perspective view of a liquid crystal television.

FIG. 2 is a partially exploded perspective view illustrating the liquid crystal television.

FIG. 3 is a cross-sectional view taken in a vertical direction the liquid crystal television in the state of FIG. 1.

FIG. 4 is a rear view of a front cabinet.

FIG. 5 is a partial perspective view illustrating the front cabinet.

FIG. 6 is a view describing an outline of placing components of a liquid crystal panel module on the front cabinet.

FIG. 7 is a view describing a positional relation between an optical sheet and first and second ribs.

FIG. 8 is a rear view of a structure around a partition rib.

FIG. 9 is a partial rear view of the front cabinet and the liquid crystal panel module corresponding to around the partition rib of FIG. 8.

FIG. 10 is a perspective view illustrating a lower right portion of a backlight chassis corresponding to around the partition rib.

FIG. 11 is a rear view of the liquid crystal television from which a back cabinet and the backlight chassis are removed.

FIG. 12 is a rear view of the liquid crystal television from which the back cabinet is removed.

FIG. 13 is a plan view of the back cabinet as seen from a front side.

FIG. 14 is a perspective view of the back cabinet.

FIG. 15A is a view describing an assembling procedure of the liquid crystal television.

FIG. 15B is a view describing an assembling procedure of the liquid crystal television.

FIG. 15C is a view describing an assembling procedure of the liquid crystal television.

FIG. 15D is a view describing an assembling procedure of the liquid crystal television.

FIG. 15E is a view describing an assembling procedure of the liquid crystal television.

FIG. 15F is a view describing an assembling procedure of the liquid crystal television.

FIG. 15G is a view describing an assembling procedure of the liquid crystal television.

FIG. 16 is a rear view of a discharge prevention frame.

FIG. 17 is a partially enlarged perspective view illustrating the discharge prevention frame.

FIG. 18 is a partially enlarged perspective view illustrating the front cabinet and the discharge prevention frame.

FIG. 19 is a view describing an outline of placing the component of the liquid crystal panel module on the front cabinet.

### DETAILED DESCRIPTION

Hereinafter, a liquid crystal television according to one embodiment of the present invention will be described in detail with reference to the accompanying drawings illustrating the embodiments thereof. The liquid crystal television according to the present embodiment includes an edge light type backlight. The liquid crystal television according to the present embodiment excludes the bezels which surround and cover each component of a liquid crystal panel module from the outside of the four peripheral edges. Meanwhile, the present invention is not intended to be limited to the following embodiments.

### Embodiment 1

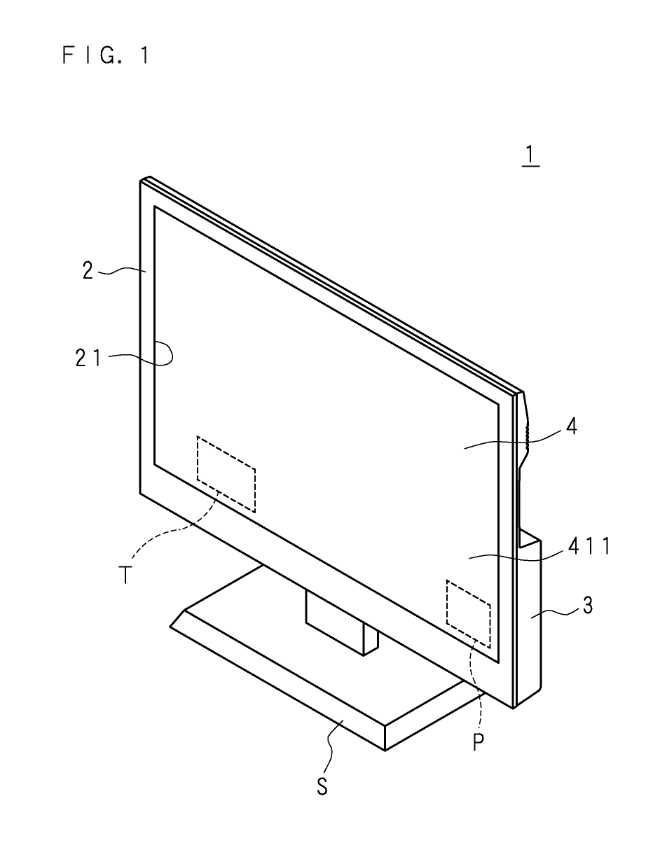

FIG. 1 is a schematic perspective view of a liquid crystal television 1. Herein, when a viewer faces a screen 411 that displays an image by the liquid crystal television 1, the viewer side of the screen 411 will be referred to as a front side and the inward side of the screen 411, which is the opposite side thereof, will be referred to as a back or rear side. The screen 411 has a laterally long and substantially rectangular shape, and from a viewer's position of facing the screen 411, the right side of the screen 411 in a longitudinal direction thereof will be referred to as right and the left side of the screen 411 in the longitudinal direction will be referred to as left. When facing the back side of the liquid crystal television 1, the left and right are inverted with the left and right of the front side. Further, from a viewer's position of facing the screen 411, the upper side of the screen 411 in a lateral direction thereof will be referred to as top and the lower side of the screen 411 in the lateral direction will be referred to as bottom. FIG. 1 illustrates the liquid crystal television 1 as seen obliquely from the front upper right.

The liquid crystal television 1 includes a front cabinet 2, a back cabinet 3, a liquid crystal panel module 4, a receiving unit T, a power source substrate P, and a stand S. The liquid crystal panel module 4 has the screen 411 on the front thereof, and is housed between the front cabinet 2 on the front side and the back cabinet 3 on a back side.

The front cabinet 2 is made of, for example, a resin and is formed in a rectangular frame shape. The front cabinet 2 encloses a front peripheral edge part and an outer peripheral surface of the liquid crystal panel module 4. The front cabinet 2 has an opening 21 formed in a laterally long rectangular shape at a substantial center, and the screen 411 of the liquid crystal panel module 4 is viewed through the opening 21. Side parts of a narrow width for covering opposite sides of the liquid crystal panel module 4 are disposed on the outer periphery of the front cabinet 2 at the back side thereof.

The back cabinet 3 covers the liquid crystal panel module 4 from the back side. The back cabinet 3 is made of, for example, a resin, and is formed in a substantial dish shape. Side parts for covering the opposite sides of the liquid crystal panel module 4 are disposed on the outer periphery of the back cabinet 3 at a front thereof, and a raising height of the side parts is greater than that of the side parts of the front cabinet 2. Tip end parts of the side parts of the back cabinet 3 are fitted to an inner peripheral surface of the side parts of the front cabinet 2.

The receiving unit T receives an image signal relating to television broadcasts. The power source substrate P supplies power to each component of the liquid crystal television 1.

The stand S is provided with a post which is bonded to a lower center of the liquid crystal television 1 on an upper surface center thereof, and is a plate for supporting the liquid crystal television 1 in an upright state.

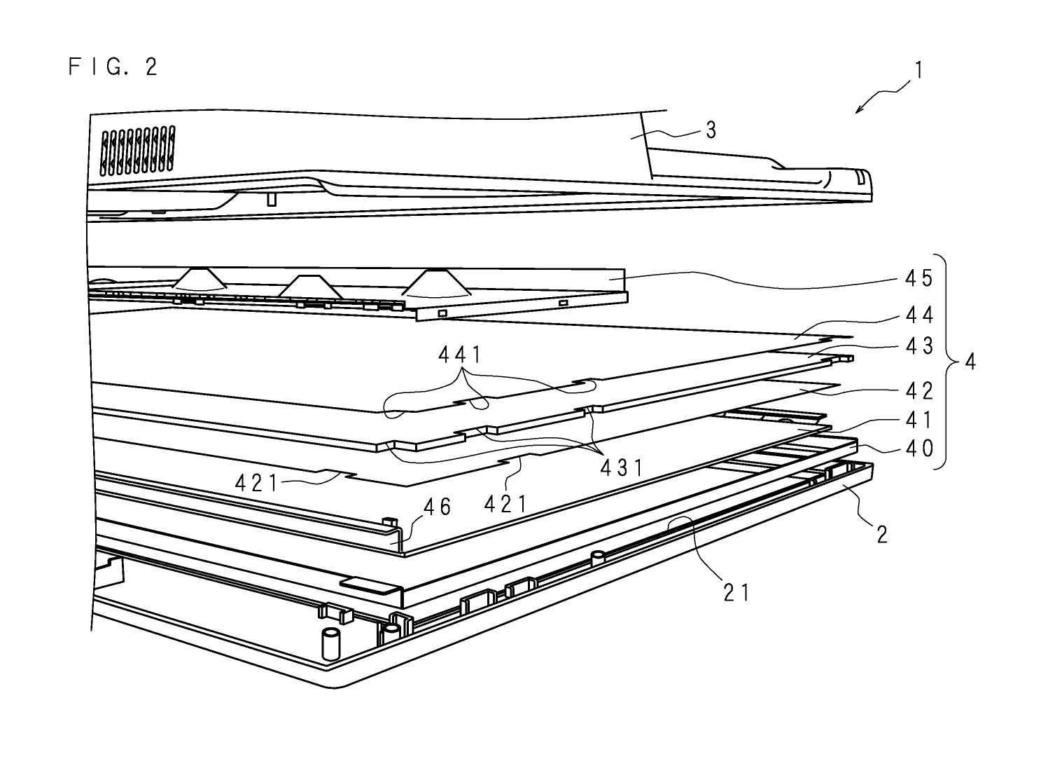

FIG. 2 is a partially exploded perspective view illustrating the liquid crystal television 1. FIG. 2 illustrates the state in which each component of the liquid crystal panel module 4 are separated from each other and arranged from the bottom to the top between the front cabinet 2 and the back cabinet 3 as seen from the side. FIG. 2 illustrates the liquid crystal television 1 in such a way that the lower right part thereof in the state of FIG. 1 is positioned in the front.

In FIG. 2, the liquid crystal panel module 4 includes each component of a discharge prevention frame 40, a liquid crystal panel 41, an optical sheet 42, a light guide plate 43, a reflective sheet 44 and a backlight chassis (a cover) 45, which are arranged from the bottom to the top in this order.

The discharge prevention frame 40 is a rectangular shaped frame that rims the outside of the opening 21 of the back face of the front cabinet 2, and is made of a metal material having electrical conductivity. The discharge prevention frame 40 has a function to prevent the influence of the discharge from the outside of the liquid crystal television 1 to the receiving unit T, power source substrate P and the like.

The liquid crystal panel 41 is a plate-shaped component having a rectangular surface wider than the opening 21. The liquid crystal panel 41 has the screen 411 on the front thereof.

In FIG. 2, a heat sink 46 is illustrated in the front portion of the liquid crystal panel 41. The heat sink 46 will be described below. Moreover, in FIG. 2, a light emitting diode (LED) substrate and an LED (a light source) mounted thereon, which are hidden in the drawing, are provided in the back side of the heat sink 46. That is, the LED which serves as the light source of the backlight is disposed at a lowermost portion of the liquid crystal panel module 4 in the liquid crystal television 1 in the state of FIG. 1.

The optical sheet 42 is a synthetic resin sheet, and includes a prism sheet, a diffusion sheet and a reflective polarizing sheet. The optical sheet 42 has a function of uniformly diffusing light emitted from the light guide plate 43 to the liquid crystal panel 41. The optical sheet 42 is formed in substantially the same shape as the back face of the liquid crystal panel 41, except that several notches 421 are formed in the peripheral end of the optical sheet 42.

The light guide plate 43 is formed in a rectangular plate shape, and is made of an acrylic resin. Areas of the front and back face of the light guide plate 43 are slightly wider than the area of the optical sheet 42. Several recesses 431 are formed in a side part of the light guide plate 43.

The reflective sheet 44 disposed between the light guide plate 43 and the backlight chassis 45 is a sheet made of a white resin, silver, aluminum or the like. The reflective sheet 44 is disposed on the back face of the light guide plate 43. The reflective sheet 44 is formed in substantially the same shape as the back face of the light guide plate 43. For example, notches 441 having the same shape as the recesses 431 are formed at positions of the reflective sheet 44 corresponding to the recesses 431 of the light guide plate 43.

The backlight chassis 45 is made of a metal and formed in a rectangular shape. The area of the backlight chassis 45 is slightly wider than that of the light guide plate 43.

In addition, the receiving unit T and the power source substrate P are fixed to the back face of the backlight chassis 45 by screws.

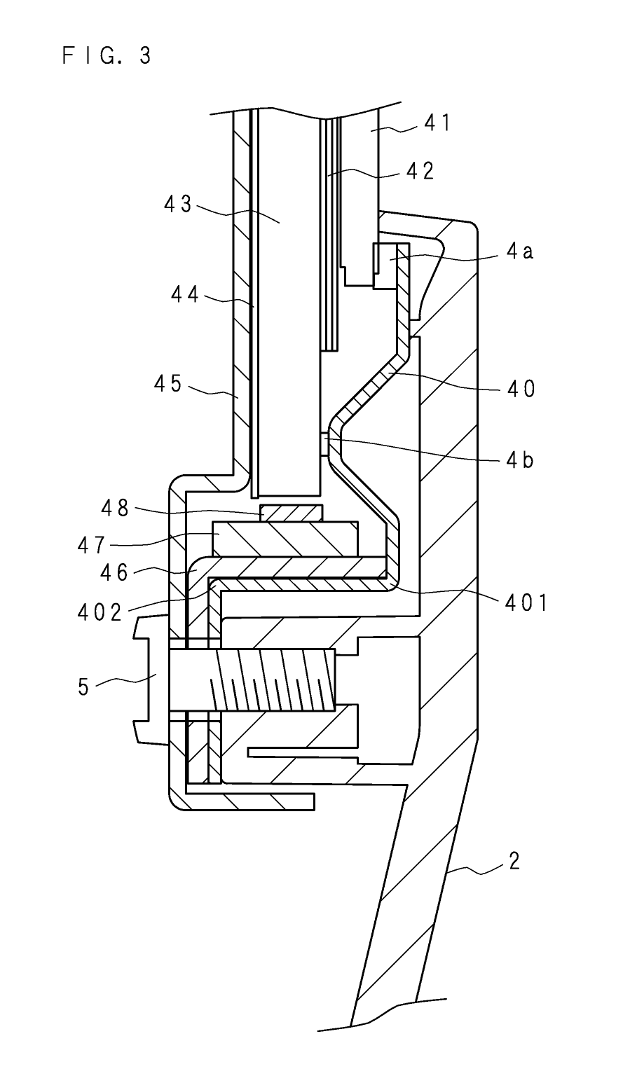

FIG. 3 is a cross-sectional view taken in a vertical direction the liquid crystal television 1 in the state of FIG. 1. The right side of FIG. 3 corresponds to the front side of the liquid crystal television 1 and the left side of FIG. 3 corresponds to the back side of the liquid crystal television 1. In FIG. 3, the liquid crystal panel module 4 is disposed between the front cabinet 2 and the back cabinet 3, and abuts the front cabinet 2.

The light guide plate 43 uniformizes LED light incident from a lower side face thereof by inward diffusion. The light guide plate 43 surface emits the uniformed light from the front face thereof to the optical sheet 42. The reflective sheet 44 reflects the light inside of the light guide plate 43 to the front side, thereby increasing the usage efficiency of light from the LED. The optical sheet 42 diffuses the light received from the light guide plate 43 and, emits it to the liquid crystal panel 41. The liquid crystal panel 41 takes in the light emitted from the optical sheet 42 through the back face thereof, and displays an image relating to television broadcasts received by the receiving unit T on the screen 411 of the front side.

The liquid crystal panel 41, the optical sheet 42, the light guide plate 43 and the reflective sheet 44 are disposed in a laminated state between the discharge prevention frame 40 and the backlight chassis 45. An upper portion of the discharge prevention frame 40 contacts with a lower end of the liquid crystal panel 41 through a spacer 4a and, a portion thereof contacts with a lower portion of the light guide plate 43 through a spacer 4b. The portion of the discharge prevention frame 40 contacting with the light guide plate 43 protrudes to the back side, and forms a bent portion such as an angular or an inverted V shape. The discharge prevention frame 40 has a bent portion 401, which is formed on a lower portion thereof from the bent portion to be bent at substantially a right angle to the back side, and a bent portion 402, which is disposed on a further lower portion thereof. The discharge prevention frame 40 is provided with a horizontal plate portion extending reward between the bent portion 401 and the bent portion 402, and a vertical plate portion which is formed on a lower end of the discharge prevention frame 40 from the bent portion 402 down as a free end. The horizontal plate portion of the discharge prevention frame 40 faces to a lower side face of the light guide plate 43 in a spaced-apart state.

The liquid crystal panel module 4 includes the heat sink 46, an LED substrate 47 and an LED 48. The heat sink 46 is made of aluminum, copper or the like having good thermal conductivity, and serves as a member to transfer heat from the LED 48 to the backlight chassis 45. The heat sink 46 is formed in an L shape as illustrated in FIG. 3. A longitudinal plate portion and a vertical plate portion of the heat sink 46 are in close contact with the horizontal plate portion and the vertical plate portion of the discharge prevention frame 40 so as to join the bent portion thereof with the bent portion 402 of the discharge prevention frame 40, respectively.

The LED substrate 47 has a flat elongated rectangular shape, and is fixed onto the horizontal plate portion of the heat sink 46 by screws (not illustrated). Then, a plurality of LEDs 48 are mounted on the LED substrate 47 in a manner that they are arranged at substantially equal intervals along a longitudinal direction of the LED substrate 47. Further, the discharge prevention frame 40, the heat sink 46, the LED substrate 47 and the LED 48 are positioned so as to be disposed on the lower side face of the light guide plate 43 directly above the LED 48 with a small gap.

The discharge prevention frame 40 and the heat sink 46 in a laminated state are positioned between the backlight chassis 45 and the front cabinet 2, and then screwed together by a screw 5. The screw 5 is inserted from the backlight chassis 45, and is screwed to a boss projecting from the back face of the front cabinet 2.

The front cabinet 2 and the backlight chassis 45 fastened by the screw 5 press the discharge prevention frame 40, the liquid crystal panel 41, the optical sheet 42, the light guide plate 43 and the reflective sheet 44 in a laminated state.

A plurality of fixed positions corresponding to the screws 5 of FIG. 3 are provided at the bottom of the liquid crystal panel module 4.

In a conventional liquid crystal television, each component of the liquid crystal panel module is fixed by the bezels. However, the liquid crystal television 1 excludes the bezel. Therefore, each component of the liquid crystal panel module 4 is fixed by fastening the screws 5 between the backlight chassis 45 and the front cabinet 2, as described above.

The bezel has a function to position the components when assembling the liquid crystal television. Also, the bezel has a function to fix the optical sheet without bending the same. Further, the bezel has a function to prevent the LED light from leaking to the outside of the liquid crystal panel module.

The liquid crystal television 1 includes a structure having the functions for positioning of the components, fixing of the optical sheet in a state of without deforming the optical sheet, and preventing light leakage, which are provided by a bezel in the art. Next, the structure of the liquid crystal television 1 to replace the above-described function of the bezel will be described.

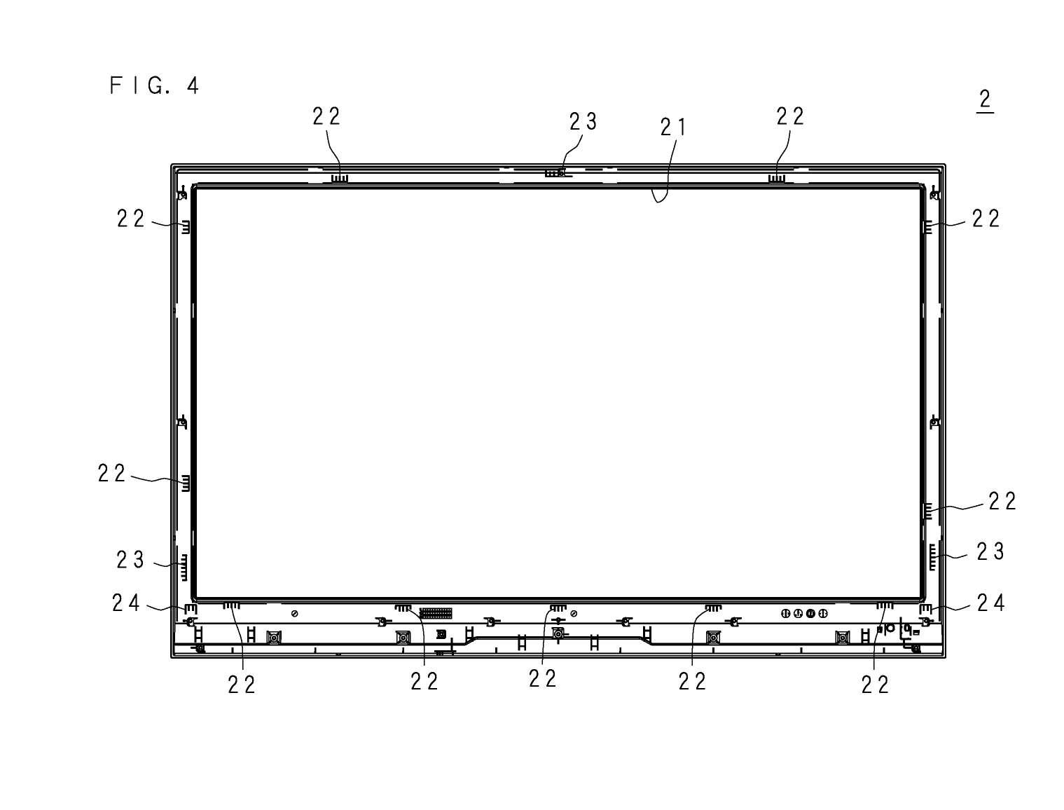

FIG. 4 is a rear view of the front cabinet 2. The front cabinet 2 is formed in a laterally long rectangular shape and is provided with the opening 21, through which the screen 411 of the liquid crystal panel 41 can be viewed, in the front. That is, the front cabinet 2 has a frame shape. The width of an upper frame section, a left frame section and a right frame section in the front cabinet 2 are substantially the same. On the other hand, the width of a lower frame section of the front cabinet 2 is wider than the width of the other frame sections thereof.

The front cabinet 2 includes first ribs 22, second ribs 23 and partition ribs 24. The first ribs 22, the second ribs 23 and the partition ribs 24 are formed integrally with the front cabinet 2 by a molding die.

A plurality of first ribs 22 are disposed on the back face of the front cabinet 2 in substantially equal intervals along the periphery of the opening 21. The number of the first ribs 22 provided on the back face of the front cabinet is two in an upper frame section, two in left and right frame sections, respectively, and five in a lower frame section. A narrow width flange is formed between the peripheral end of the opening 21 and the inner end of the first ribs 22.

A plurality of second ribs 23 are disposed on the back face of the frame of the front cabinet 2 along the periphery of the opening 21 at positions of the outside with respect to the opening 21 from the first ribs 22. The number of the second ribs 23 provided on the back face of the front cabinet is one in the upper frame section, and one in the left and right frame sections, respectively. The lower frame section of the front cabinet is not provided with the second rib 23. The second ribs 23 provided on the upper frame section and the left and right frame sections are arranged substantially in the center of the frame with respect to a width direction, respectively. The first ribs 22 and the second ribs 23 are arranged in a zigzag shape along the peripheries of the left frame section, the upper frame section and the right frame section of the front cabinet 2.

The second ribs 23 provided on the upper frame section are disposed substantially in the center of the horizontal and vertical directions of the upper frame section. Two first ribs 22 provided on the upper frame section are arranged at positions nearer the left and right ends from the left and right ends of the upper frame section and the second ribs 23 of the upper frame section, respectively.

The second ribs 23 which are respectively provided on the left and right frame sections are arranged at positions corresponding to the lower side from a midpoint of a short side of the opening 21. In particular, the second ribs 23 which are respectively provided on the left and right frame sections are arranged at positions slightly upward and apart from the lower left and right corners of the opening 21. The first ribs 22 which are respectively provided on the left and right frame sections in twos are arranged at an upper side from the second ribs 23 provided on the left and right frame sections.

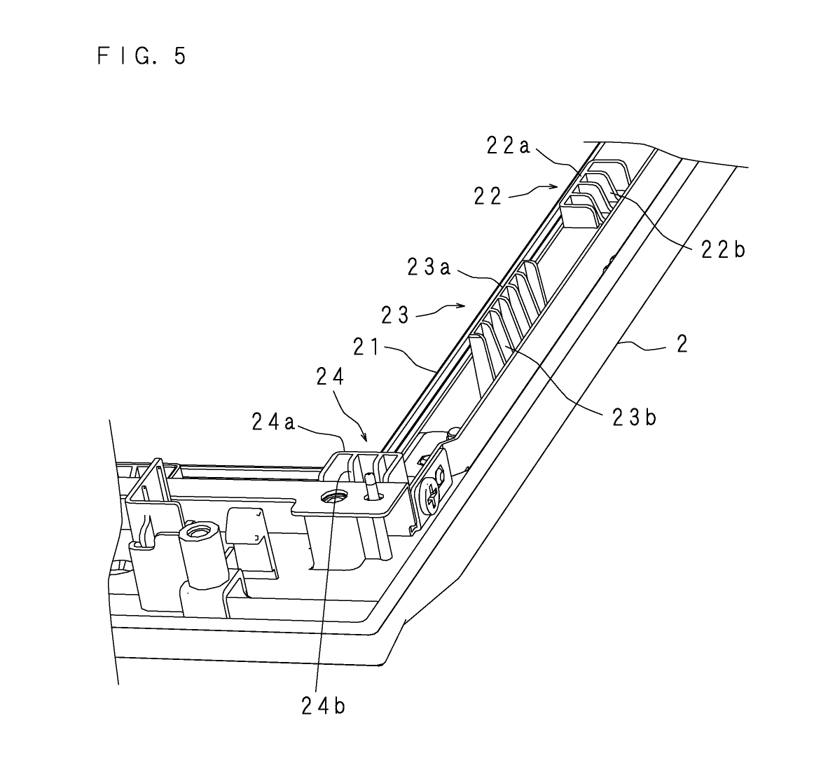

FIG. 5 is a partial perspective view illustrating the front cabinet 2. FIG. 5 illustrates the first ribs 22 and the second ribs 23 provided on the lower right portion of the back face of the front cabinet 2 as seen obliquely from the lower right.

The height of the first ribs 22 with respect to the front cabinet 2 is lower than the height of the second ribs 23. The height of the first ribs 22 is slightly greater than a total thickness of the liquid crystal panel 41 and the optical sheet 42. The height of the second ribs 23 is slightly greater than a total thickness of the liquid crystal panel 41, the optical sheet 42, the light guide plate 43 and the reflective sheet 44. The heights of the first ribs 22 and the second ribs 23 are adjusted such that differences in height between the first ribs 22 and the second ribs 23 are to be equal to a total thickness of the light guide plate 43 and the reflective sheet 44.

The first rib 22 includes a first main rib 22a and first sub ribs 22b. The first main rib 22a is a rib substantially parallel to a side of the opening 21. The first sub ribs 22b are provided so as to protrude from both ends of the first main rib 22a to the outside with respect to the opening 21 and in a direction substantially perpendicular to the first main rib 22a. Hereinafter, the first sub ribs 22b provided on both ends of the first main rib 22a are referred to as both side ribs. When the back face of the front cabinet 2 is disposed upward and facing the side of the front cabinet 2 from a lateral direction, the both side ribs have, for example, substantially a rectangular shape.

A plurality of first sub ribs 22b are also provided in the middle of the both side ribs, thereby a total of five first sub ribs 22b are provided in this embodiment. The first sub ribs 22b provided between the both side ribs are arranged in parallel to the both side ribs at substantially equal intervals at a corner forming a side wall of the first main rib 22a of the outside with respect to the opening 21 and the back face of the front cabinet 2. When the back face of the front cabinet 2 is disposed upward and the front cabinet 2 is seen from the lateral direction, the first sub rib 22b has, for example, a trapezoidal shape having a base longer than the upper base. In this case, the inner sides of the first sub ribs 22b provided between the both side ribs are substantially perpendicular to the base, and outer sides thereof are inclined to the back face of the front cabinet 2.

The second rib 23 includes a second main rib 23a and second sub ribs 23b. The arrangement direction and shape of the second main rib 23a and the second sub ribs 23b are similar to the first main rib 22a and the first sub ribs 22b, respectively. In this embodiment, a total of seven second sub ribs 23b are provided.

When the front cabinet 2 is seen from the back side, the overall shape of the first rib 22 and the second rib 23 is a comb shape, respectively.

In FIG. 4, each of the partition ribs 24 projects upward from the back face of the lower frame section near the lower left and right corners of the opening 21, respectively.

FIG. 5 illustrates the partition ribs 24 provided on the lower right portion of the back face of the front cabinet 2 as seen obliquely from the lower right. The height of the partition ribs 24 with respect to the back face of the front cabinet 2 is substantially the same as the height of the second ribs 23, and corresponds to a height slightly greater than the total thickness of the liquid crystal panel 41, the optical sheet 42, the light guide plate 43 and the reflective sheet 44.

The partition ribs 24 include a partition body rib 24a and partition reinforcing ribs 24b. The partition body rib 24a has a rib substantially parallel to the longer side of the opening 21 and ribs extending downward from the both ends of the rib. When the back face of the front cabinet 2 is disposed upward and facing the lateral side of the front cabinet 2, the shape of the partition body rib 24a is substantially a rectangular shape. When seeing the front cabinet 2 from the back side, the partition body rib 24a has substantially a U shape.

In this embodiment, two partition reinforcing ribs 24b are provided. The partition reinforcing ribs 24b are provided at substantially equal intervals at the corners forming the side wall of the partition body rib 24a of the outside with respect to the opening 21 and back face of the front cabinet 2. The partition reinforcing ribs 24b are oriented downward. When the back face of the front cabinet 2 is disposed upward and facing the lateral side of the front cabinet 2, the shape of the partition reinforcing ribs 24b is a trapezoidal shape having a base longer than the upper side. In this case, the inner sides of the partition reinforcing ribs 24b are substantially perpendicular to the base, and outer sides thereof are inclined to the back face of the front cabinet 2.

When seeing the front cabinet 2 from the back side, the overall shape of the partition ribs 24 is a comb shape.

In the first ribs 22, the second ribs 23 and the partition ribs 24, the first sub ribs 22b, the second sub ribs 23b and the partition reinforcing ribs 24b have a function to increase the strength of the first ribs 22, the second ribs 23 and the partition ribs 24, respectively. In addition, the provided first sub ribs 22b, the second sub ribs 23b and the partition reinforcing ribs 24b also have a function to inhibit sagging of the molding occurring at the front position of the front cabinet 2 corresponding to the first ribs 22, the second ribs 23 and the partition ribs 24, respectively.

In FIG. 4, a distance between the inner position of the first rib 22 disposed on the upper frame section of the front cabinet 2 and the inner position of the first rib 22 disposed on the lower frame section is substantially equal to the length of the liquid crystal panel 41 in the lateral direction. A distance between the inner position of the first ribs 22 which are respectively disposed on the left and right frame sections of the front cabinet 2 is substantially equal to the length of the liquid crystal panel 41 in the longitudinal direction.

In FIG. 4, a distance between the inner position of the second rib 23 disposed on the upper frame section of the front cabinet 2 and the inner position of the partition rib 24 disposed on the lower frame section is substantially equal to the length of the optical sheet 42, the light guide plate 43 and the reflective sheet 44 in the lateral direction, respectively. A distance between the inner position of the second rib 23 which are respectively disposed on the left and right frame sections of the front cabinet 2 is substantially equal to the length of the optical sheet 42, the light guide plate 43 and the reflective sheet 44 in the longitudinal direction, respectively.

When assembling the liquid crystal television 1, the back face of the front cabinet 2 is disposed upward, and the front cabinet 2 is placed on a substantially horizontal plane. The discharge prevention frame 40 is laminated on the outer peripheral edge part of the front cabinet 2 in a state of overlapping with the front cabinet 2. The liquid crystal panel 41 is housed in a space between the first ribs 22 disposed along the peripheral edge of the opening 21. Then, the optical sheet 42, the light guide plate 43 and the reflective sheet 44 are housed in a space between the second ribs 23 and the partition rib 24.

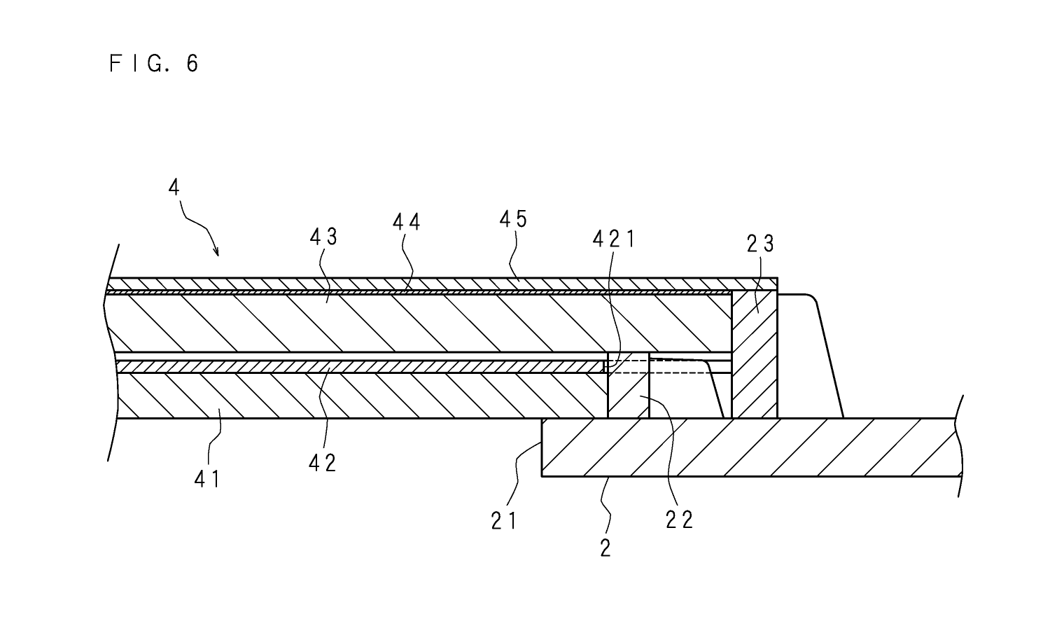

FIG. 6 is a view describing an outline of placing components of the liquid crystal panel module 4 on the front cabinet 2. In FIG. 6, the left side corresponds to the inside of the front cabinet 2, and the left end of the front cabinet 2 is intercepted at the periphery of the opening 21. In FIG. 6, the right side corresponds to the outside of the front cabinet 2. FIG. 6 describes the outline of the liquid crystal panel 41, the optical sheet 42, the light guide plate 43 and the reflective sheet 44 which are laminated on the front cabinet 2 by the positional relationship with respect to the first ribs 22 and the second ribs 23. In fact, the first rib 22 and the second rib 23 are isolated from each other, however, the first rib 22 and the second rib 23 in FIG. 6 are illustrated by protruding in a normal direction of FIG. 6, and are drawn close to each other.

An edge part of the front face of the liquid crystal panel 41 abuts the edge of the front cabinet 2 around the opening 21, and the side face of the liquid crystal panel 41 abuts the inner surface of the first ribs 22. The optical sheet 42 is laminated on the liquid crystal panel 41, and the peripheral edge of the optical sheet 42 is spaced apart from the inner surface of the first rib 22 with a small gap.

The peripheral end of the optical sheet 42 is a portion facing the first rib 22 and a portion facing the second rib 23. A solid line of the optical sheet 42 illustrates a peripheral end part of the optical sheet 42 facing the first rib 22. A broken line of the optical sheet 42 and the solid line on the right side thereof illustrate a peripheral end part of the optical sheet 42 facing the second rib 23.

The peripheral edge of the optical sheet 42 facing the first rib 22 is spaced slightly apart from the inner surface of the first rib 22. The peripheral edge of the optical sheet 42 facing the second rib 23 further extends to the outside to abut the inner surface of the second rib 23.

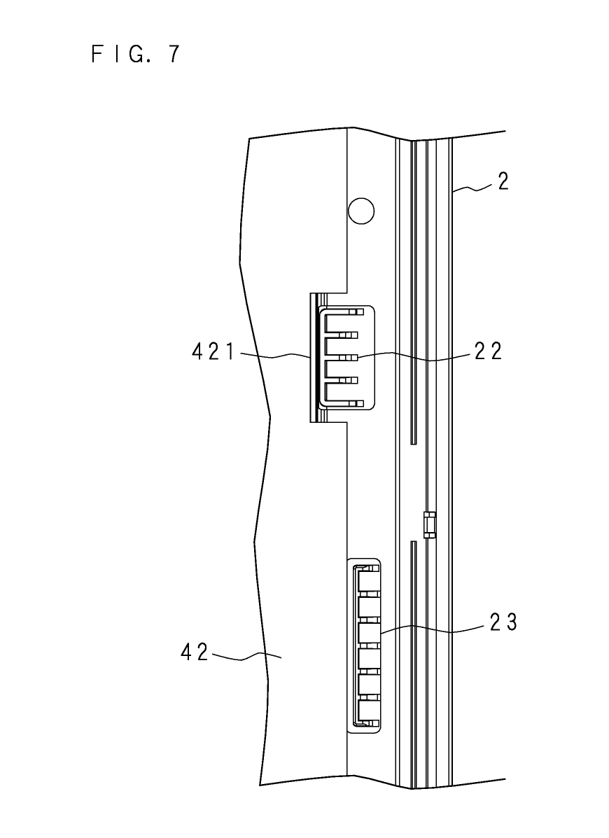

FIG. 7 is a view describing a positional relation between the optical sheet 42 and the first and second ribs 22 and 23. In a process of assembling the liquid crystal television 1, FIG. 7 illustrates a step in which the optical sheet 42 is exposed to the back side. In FIG. 7, the left side corresponds to the inside of the optical sheet 42, and the right side corresponds to the outside of the optical sheet 42. The peripheral edge of the optical sheet 42 facing the second rib 23 abuts the inner surface of the second rib 23. On the other hand, the peripheral edge of the optical sheet 42 facing the first rib 22 is provided with a rectangular-shaped notch 421. The notch 421 is spaced apart from the first rib 22 with a small gap.

The peripheral edge of the optical sheet 42 may abut the inner surface both of the first rib 22 and the second rib 23.

Alternatively, the peripheral edge of the optical sheet 42 may abut only the inner surface of the first rib 22. In this case, the shape and size of the optical sheet 42 is substantially the same as the back face of the liquid crystal panel 41, while not provided with the notch 421.

A peripheral edge part of the front face of the light guide plate 43 in FIG. 6 abuts a tip end part of the first rib 22, and the side face of the light guide plate 43 abuts the inner surface of the second rib 23. The reflective sheet 44 is laminated on the light guide plate 43, and the peripheral edge of the reflective sheet 44 abuts the inner surface of the second rib 23. The back face of the reflective sheet 44 abuts the backlight chassis 45. A peripheral end part of the front face of the backlight chassis 45 abuts the tip end face of the second rib 23. When fastening the screws 5, a pressing force is applied to the light guide plate 43 from the backlight chassis 45 through the reflective sheet 44, and thereby the tip end face of the first rib 22 is pressed.

A gap between the optical sheet 42 and the light guide plate 43 is illustrated by enlarging in FIG. 6. However, the gap is actually very narrow, even when the pressing force is applied to the light guide plate 43 by fastening the screws 5, the optical sheet 42 is not substantially pressed due to the narrow gap. Therefore, deformation such as bending, warpage, or the like due to the pressing does not occur in the optical sheet 42.

Moreover, the function of the second rib 23 in FIG. 6 is replaced by the partition rib 24 around the corner of the lower side of the opening 21.

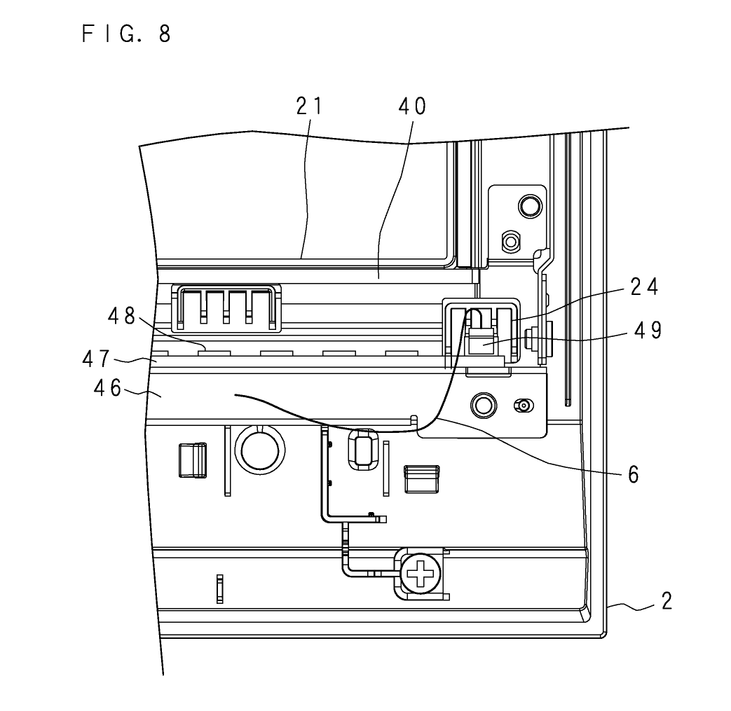

FIG. 8 is a rear view of a structure around the partition rib 24. FIG. 8 illustrates the state in which the discharge prevention frame 40, the heat sink 46, the LED substrate 47 and the LED 48 are mounted on the front cabinet 2.

The heat sink 46 extending in a lateral is illustrated in substantially the center of FIG. 8. The LED substrate 47 is fixed on the heat sink 46, and further the LED 48 is mounted on the LED substrate 47. A connector 49 which connects the power cord 6 for supplying the power to the LED 48 is installed on the right end of the LED substrate 47. The connector 49 is surrounded by the LED substrate 47 on the lower side, the partition ribs 24 on the upper side and both left and right sides, and the front cabinet 2 on the front side. The back side of the connector 49 is covered by the backlight chassis 45, not illustrated in FIG. 8.

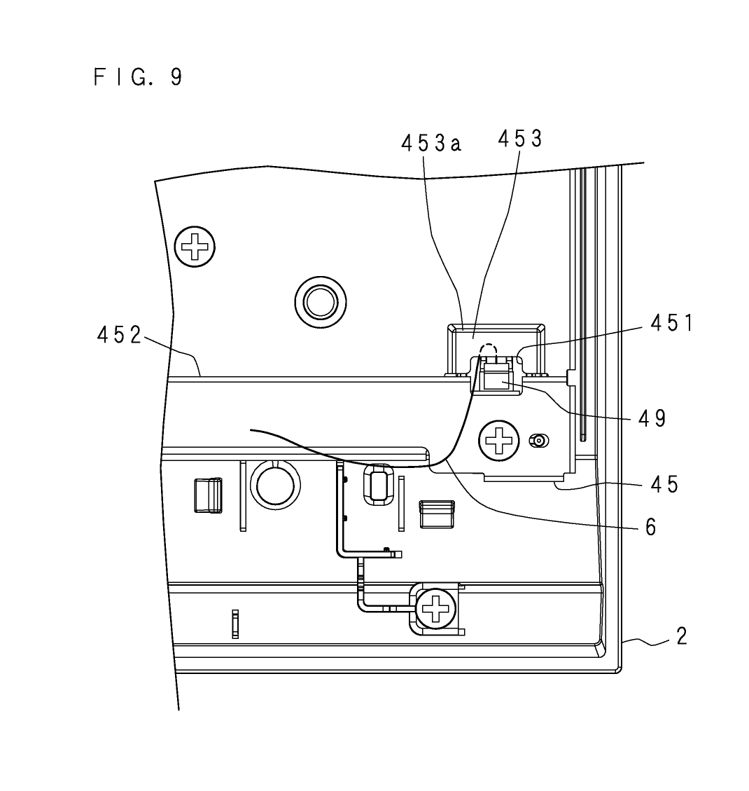

FIG. 9 is a partial rear view of the front cabinet 2 and the liquid crystal panel module 4 corresponding to around the partition rib 24 of FIG. 8. FIG. 9 illustrates the state in which the backlight chassis 45 is mounted on the liquid crystal television 1.

An aperture 451 is formed in the backlight chassis 45 at a position facing the connector 49. The aperture 451 is provided to allow the power cord 6 connected to the connector 49 to extend to the outside of the liquid crystal panel module 4. Alternately, the aperture 451 is a hole for inserting the power cord 6 to be connected to the connector 49 from the outside to the inside of the liquid crystal panel module 4. The aperture 451 has substantially a rectangular shape. However, the shape of the aperture 451 is not particularly limited thereto.

If the partition ribs 24 do not project upward from the back face of the front cabinet 2, light from the LED 48 may leak to the outside of the liquid crystal panel module 4 through the aperture 451. However, the LED 48 and the aperture 451 are blocked by the LED substrate 47, the front cabinet 2, the backlight chassis 45 and the partition ribs 24. Therefore, light from the LED 48 is not leaked to the outside of the liquid crystal panel module 4.

FIG. 10 is a perspective view illustrating a lower right portion of the backlight chassis 45 corresponding to around the partition rib 24. FIG. 10 illustrates the rear portion of the backlight chassis 45.

A lower edge part of the backlight chassis 45 has a stepped part 452 which is formed to be bent into a crank shape along the lower long side of the backlight chassis 45. A ledge part protruding to the back side is formed from the stepped part 452 to the lower end of the backlight chassis 45. The aperture 451 is formed so as to cross the stepped part 452. A dish-shaped part 453 raised to the back side in a dish shape is formed on a portion of the backlight chassis 45 corresponding to the partition ribs 24 above the stepped part 452. Therefore, a stepped part 453a is formed between the dish-shaped part 453 and a flat portion around thereof. A tip end face of the back side of the partition ribs 24 is configured to abut an inner front face of the dish-shaped part 453 and the stepped part 452, and abut a portion of the ledge part on the lower side from the stepped part 452.

The light from the LED 48 also penetrates to a portion where the tip end face of the partition ribs 24 and the inner front face of the dish-shaped part 453 are abutted each other. The stepped part 453a has a function to block a part of the light directed toward the portion where the partition ribs 24 and the dish-shaped part 453 are abutted to each other.

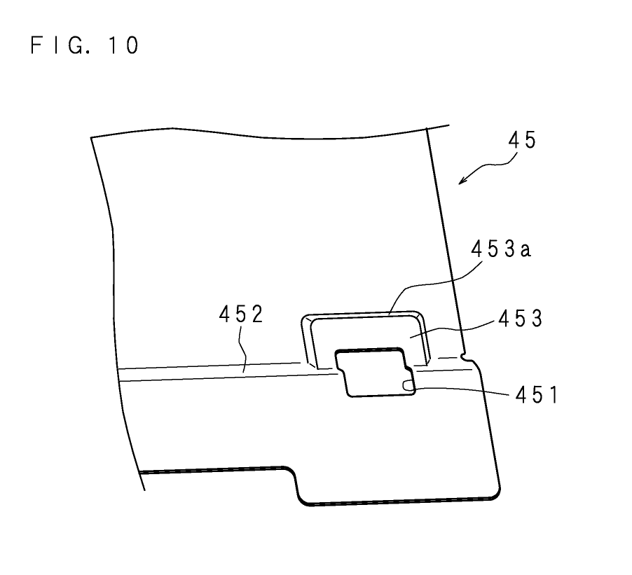

FIG. 11 is a rear view of the liquid crystal television 1 from which the back cabinet 2 and the backlight chassis 45 are removed. FIG. 11 illustrates the state in which the back face of the light guide plate 43 is widely exposed. The LED substrate 47 and the LED 48 are disposed under the light guide plate 43 with a small gap. In FIG. 11, the numeral indicating the LED 48 is omitted.

A plurality of recesses 431 are provided on the edge portions of the light guide plate 43.

Recesses 431a disposed on the upper corner of the light guide plate 43 are provided so as to avoid the fixing screws which are penetrated into the back cabinet 3 and screwed to the front cabinet 2. Recesses 431b disposed on the center of the side ends of the light guide plate 43 are the recesses 431 which are also configured to avoid the screws. Recesses 431d disposed on the lower corner of the light guide plate 43 are the recesses 431 configured to be near the partition ribs 24 as a positioning part of the light guide plate 43 and house the partition ribs 24 when assembling the liquid crystal television 1. Recesses 431c are provided between the recesses 431b disposed on the center of the side ends of the light guide plate 43 and the recesses 431d disposed on the lower corner of the light guide plate 43. The recesses 431c are the recesses 431 configured to guide the second ribs 23 as a positioning part of the light guide plate 43 to be abutted the light guide plate 43, and then fitted to the light guide plate 43.

When the LED 48 is lit, the temperature of the light guide plate 43, which is made of a material such as an acrylic resin, is increased by heat generated from the LED 48. In this case, thermal conduction velocity is high, and the light guide plate 43 becomes a uniform high temperature in a short time. Then, the light guide plate 43 is uniformly thermal expanded.

When the light guide plate 43 is thermally expanded, the distance between the light guide plate 43 and the LED 48 is decreased. In the example of FIG. 11, when the distance between the lower side face of the light guide plate 43 and the LED 48 provided under thereof is changed, a deviation in the brightness distribution of the light emitted from the light guide plate 43 is likely to occur.

The recesses 431c of the thermally expanded light guide plate 43 come into close contact with the second ribs 23 to press the second ribs 23. However, a force pressing by the recesses 431c is balanced by the reaction force from the second ribs 23, thereby preventing the movement due to the thermal deformation. On the other hand, portions of the light guide plate 43, which are disposed at the upper side and the lower side from a line segment connecting the left and right recesses 431c, are moved. At this time, since the recesses 431c and the second ribs 23 are disposed at a position lower than the half height of the light guide plate 43, a portion of the light guide plate 43 on the upper side is wider than the portion of the light guide plate 43 on the lower side. Therefore, an amount of thermal expansion of the lower side face of the light guide plate 43 is always smaller than the amount of thermal expansion of the upper side face thereof. Accordingly, by disposing the recesses 431c and the second ribs 23 on the lower side from the center position of the lateral side (the short side) of the light guide plate 43, it is possible to decrease the distance change between the lower side face of the light guide plate 43 and the LED 48 disposed under thereof. Alternatively, by disposing the recesses 431c and the second ribs 23 at a position near the lateral side of the light guide plate 43 nearest to the LED 48, than the lateral side edge of the light guide plate 43 farthermost from the LED 48, it is possible to decrease the distance change between the lower side face of the light guide plate 43 and the LED 48.

In FIG. 11, the partition ribs 24 are disposed in the lower corner of the light guide plate 43. The light guide plate 43 protruding downward due to the thermal expansion presses the partition ribs 24. However, the pressed partition ribs 24 push back against the light guide plate 43 by this reaction. Accordingly, the partition ribs 24 also have a function of reducing the distance change between the lower side face of the light guide plate 43 and the LED 48.

When the bezel for fixing the components of the liquid crystal panel module is eliminated from the liquid crystal television, the strength of the liquid crystal panel module may be reduced. Therefore, in the liquid crystal television 1, the back cabinet 3 is provided with a structure to secure the strength of the liquid crystal panel module 4.

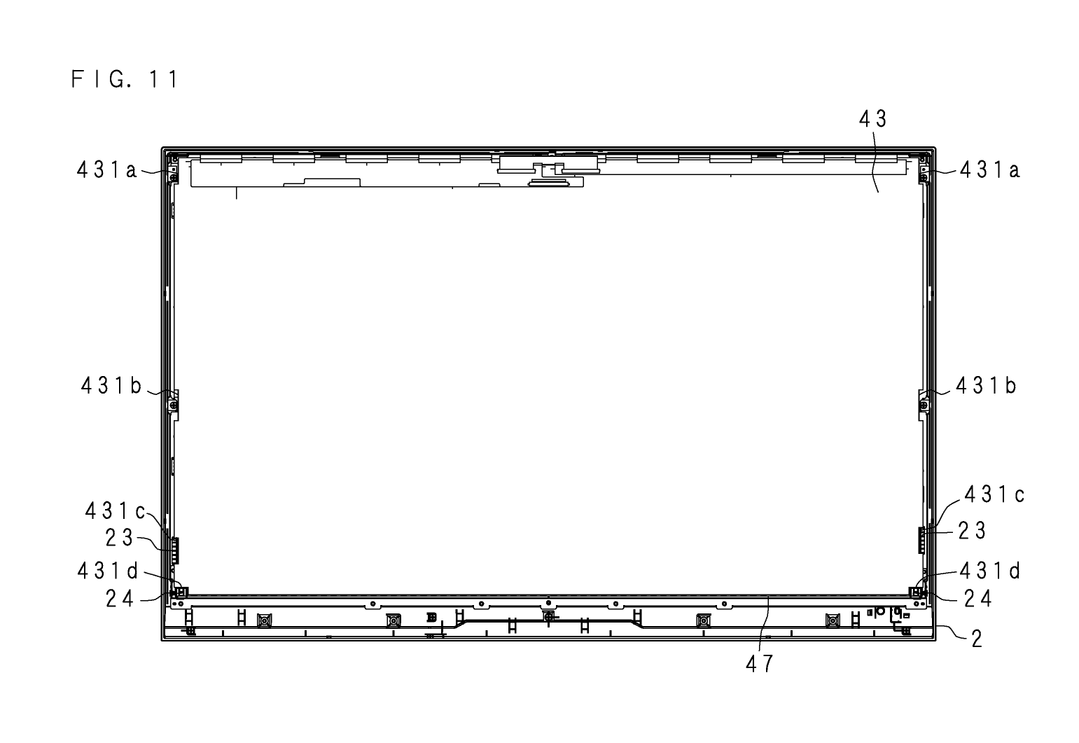

FIG. 12 is a rear view of the liquid crystal television 1 from which the back cabinet 3 is removed. In FIG. 12, the backlight chassis 45 is widely exposed. The receiving unit T and the power source substrate P are mounted on the lower portion of the back side of the backlight chassis 45. The upper portion of the back side of the backlight chassis 45 is formed in a widespread flat surface.

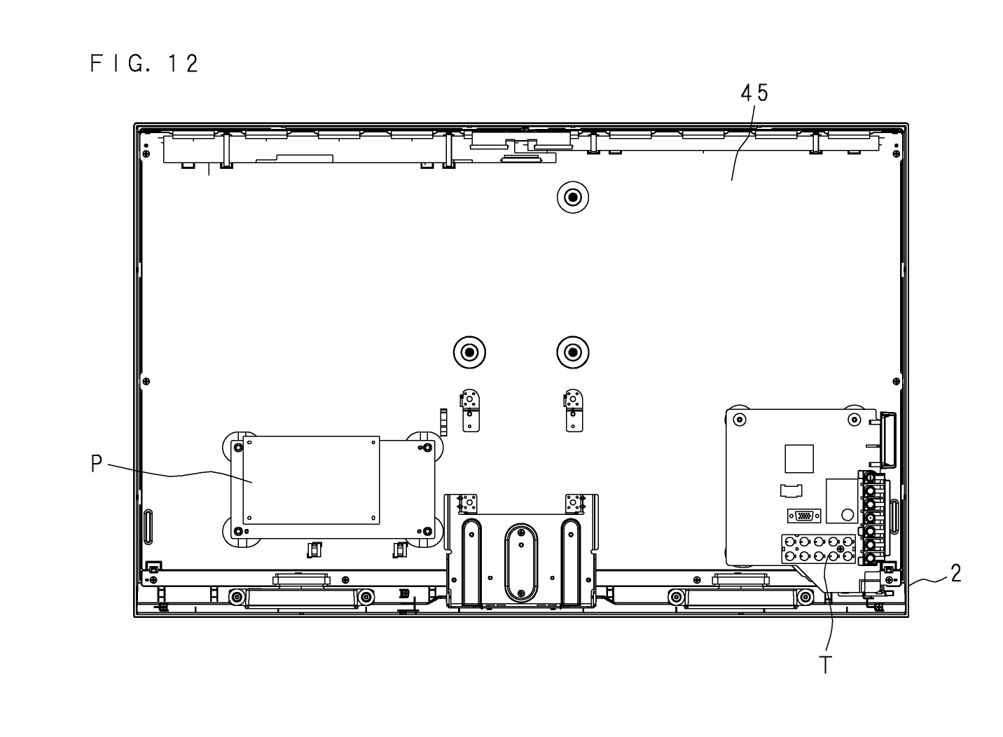

FIG. 13 is a plan view of the back cabinet 3 as seen from a front side.

The back cabinet 3 is provided with abutting ribs 31 which are formed on the upper portion of the front face thereof parallel to each other in a substantially horizontal and substantially vertical direction. The abutting ribs 31 are arranged in parallel at substantially equal intervals in both directions of the substantially horizontal direction and substantially vertical direction. The substantially horizontal abutting ribs 31 and the substantially vertical abutting ribs 31 cross at substantially right angles to form lattice or parallel cross shape. When the back cabinet 3 is incorporated in the liquid crystal television 1, the height of the abutting ribs 31 with respect to the front face of the back cabinet 3 is adjusted such that the tip end of the abutting ribs 31 abuts the flat back face portion of the backlight chassis 45. When the back cabinet 3 is screwed to the front cabinet 2, the tip end of the abutting ribs 31 presses the backlight chassis 45 by a fastening force of the screws. The pressing force is propagated to the components on the front side including the light guide plate 43, thereby increasing the strength of the liquid crystal panel module 4.

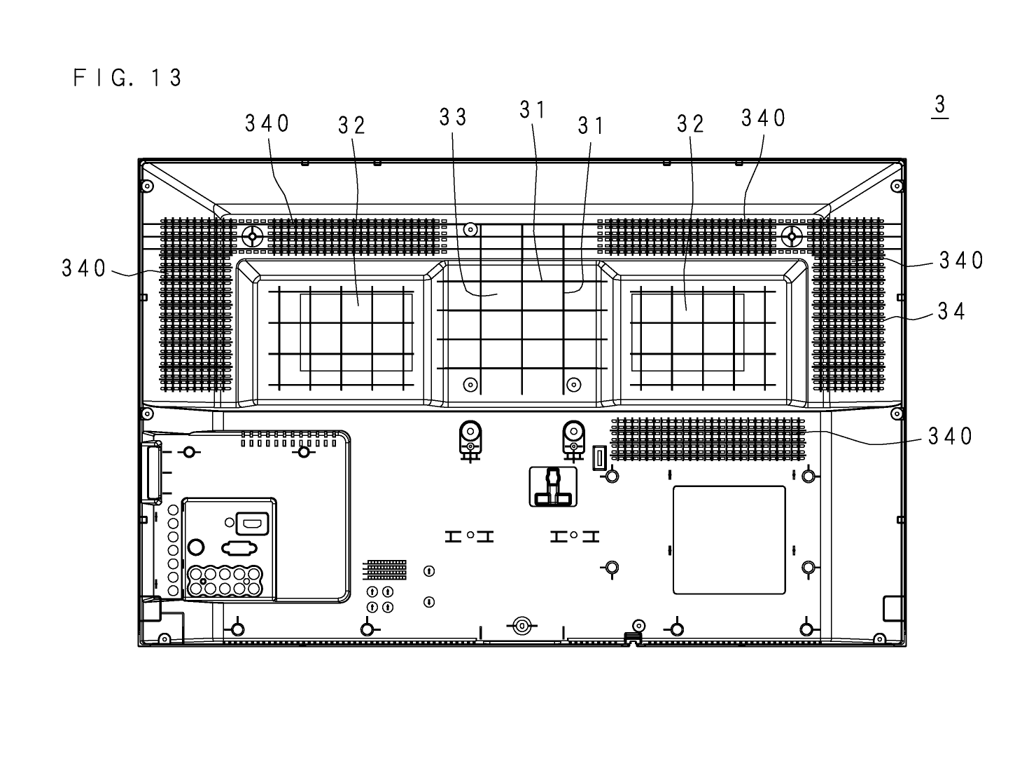

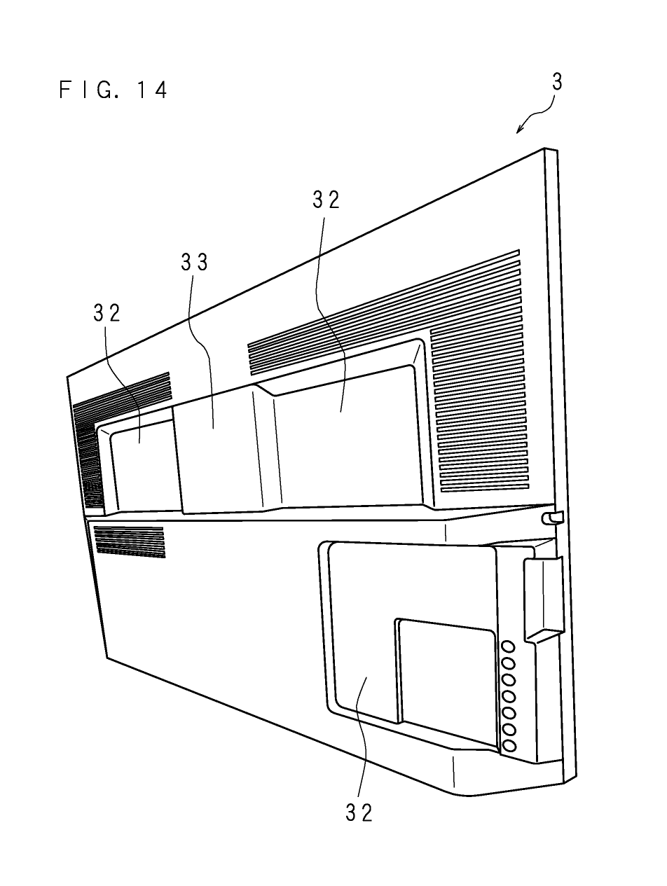

FIG. 14 is a perspective view of the back cabinet 3. FIG. 14 illustrates the back cabinet 3 as seen from the rear right side.

The back cabinet 3 is provided with two concave parts 32 which are formed on the upper portion of the back face thereof at positions separated from each other left and right from the center. The depths of the two concave parts 32 are substantially the same as each other. In addition, the two concave parts 32 have a rectangular-shaped flat bottom, and an oblique surface of an acute-angled slope which is formed between the flat bottom and a flat portion around the concave parts 32, respectively. A portion between the two concave parts 32 is formed in a convex part 33 which has a rectangular-shaped flat surface protruding relative to the concave parts 32. The flat surface of the convex part 33 is slightly depressed from the flat surfaces of the back cabinet 3 which are located at up and down thereof.

Another concave part 32, which is depressed substantially perpendicularly from the back face of the back cabinet 3, is formed on a lower portion thereof facing the receiving unit T mounted on the backlight chassis 45.

When the back cabinet 3 is formed in a convexo-concave shape having the concave parts 32 and the convex part 33, the strength thereof is increased, compared with the back cabinet 3 formed in a flat shape. The strength of the liquid crystal panel module 4 is increased by being pressed in a state of being abutted to the back cabinet 3 with increased strength. Further, the strength of the back cabinet 3 is further increased by abutting the liquid crystal panel module 4 than in a case of being formed in a single body. By such an interaction, the strength of the liquid crystal panel module 4 and the back cabinet 3 of the liquid crystal television 1 is mutually increased.

In FIG. 13, the convex-concave on the front side of the back cabinet 3 and the convex-concave on the back side are reversed with respect to each other. The convex part 33 of the upper center of the back cabinet 3 in FIG. 13 is recessed to the back side with respect to the backlight chassis 45. On the other hand, the portions of the concave parts 32 are projected with respect to the backlight chassis 45. Therefore, the abutting ribs 31 are configured in a manner that the abutting ribs 31 of the convex part 33 and the abutting ribs 31 of the concave parts 32 equally press the backlight chassis 45, by making the height of the abutting ribs 31 of the convex part 33 greater than the height of the abutting ribs 31 of the concave parts 32.

In FIG. 13, the back cabinet is provided with heat dissipation holes 34 around the concave parts 32 to release heat inside of the liquid crystal television 1 to the outside. A plurality of heat dissipation holes 34 may be provided. In this case, the plurality of heat dissipation holes 34 are arranged in parallel to each other in two directions of the substantially horizontal and substantially vertical. The region of the back cabinet 3 which is provided with the plurality of heat dissipation holes 34 is formed with heat dissipation hole parts 340 which are clearly distinguishable in appearance from other regions.

The heat dissipation hole parts 340 are formed in an L shape so as to rim two sides of the rectangle-shaped concave parts 32 on the outside of the two concave parts 32 in FIG. 13, respectively. Further, another rectangular-shaped heat dissipation hole part 340 is provided between the lower portion of the back cabinet 3 facing the power source substrate P and the concave parts 32 of the right side above thereof.

The parallel cross-shaped abutting ribs 31 are also provided on the heat dissipation hole parts 340. Specifically, other abutting ribs 31, which are arranged in parallel to each other in both directions of the substantially horizontal and substantially vertical at equal intervals, are provided on a portion between the plurality of the heat dissipation holes 34 arranged in the heat dissipation hole parts 340 or around the heat dissipation holes 34. Thereby, it is possible to expand the range where the abutting ribs 31 abut the backlight chassis 45.

Next, an assembling method of the liquid crystal television 1 will be described.

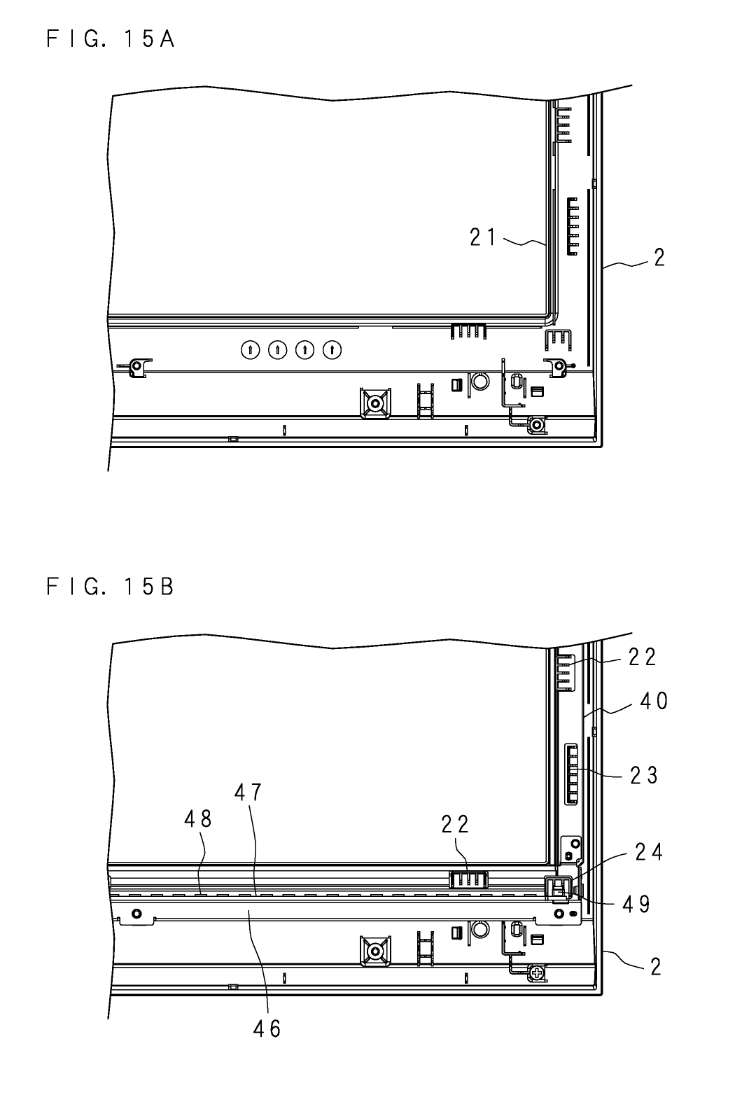

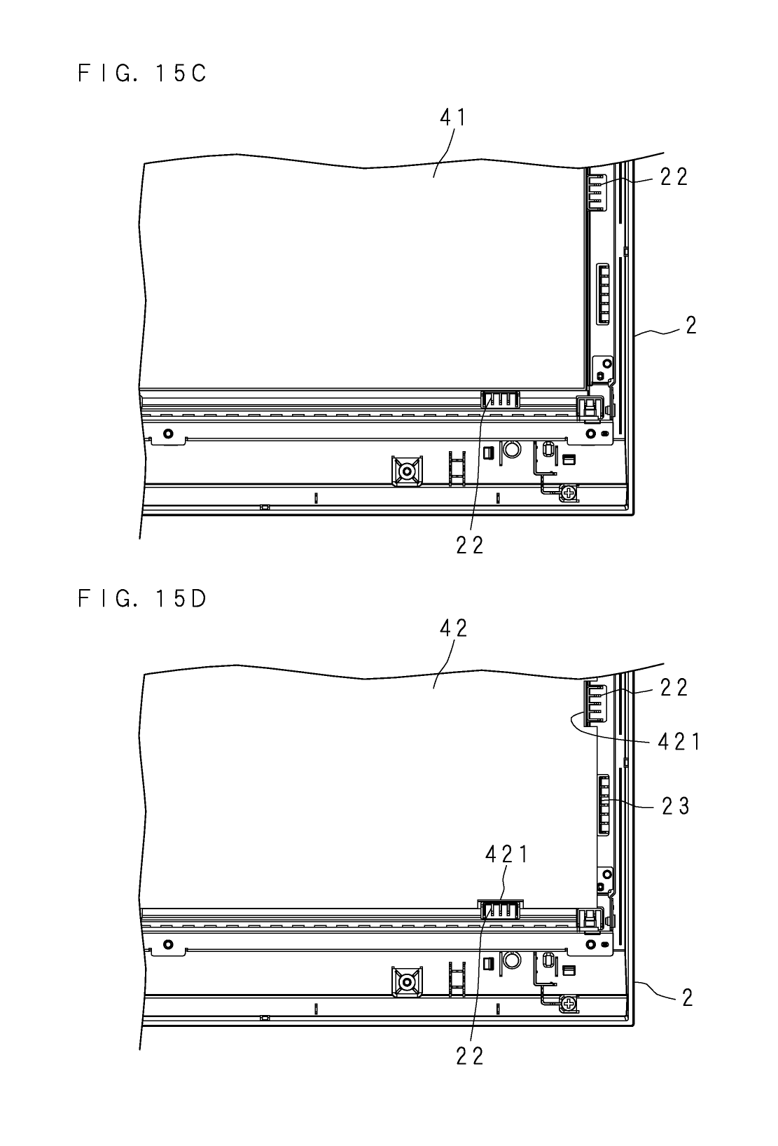

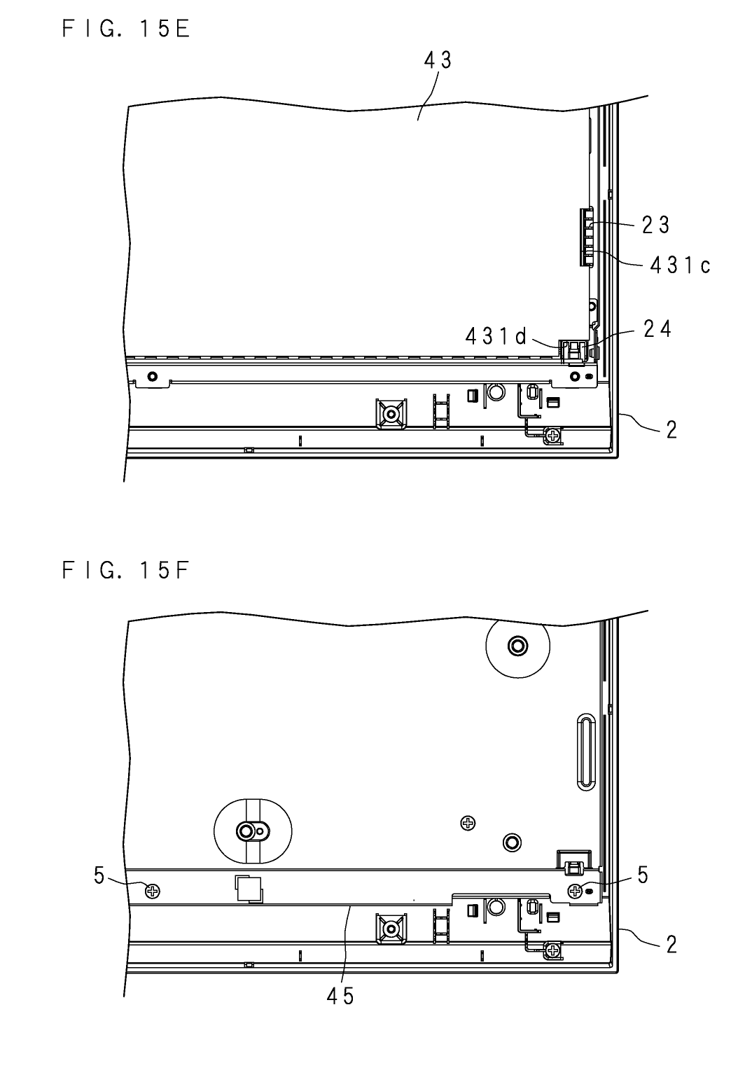

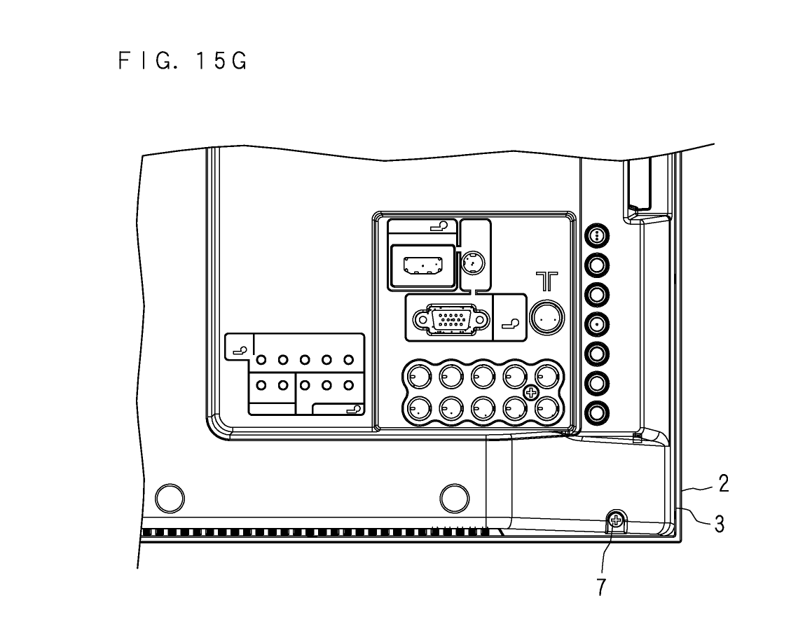

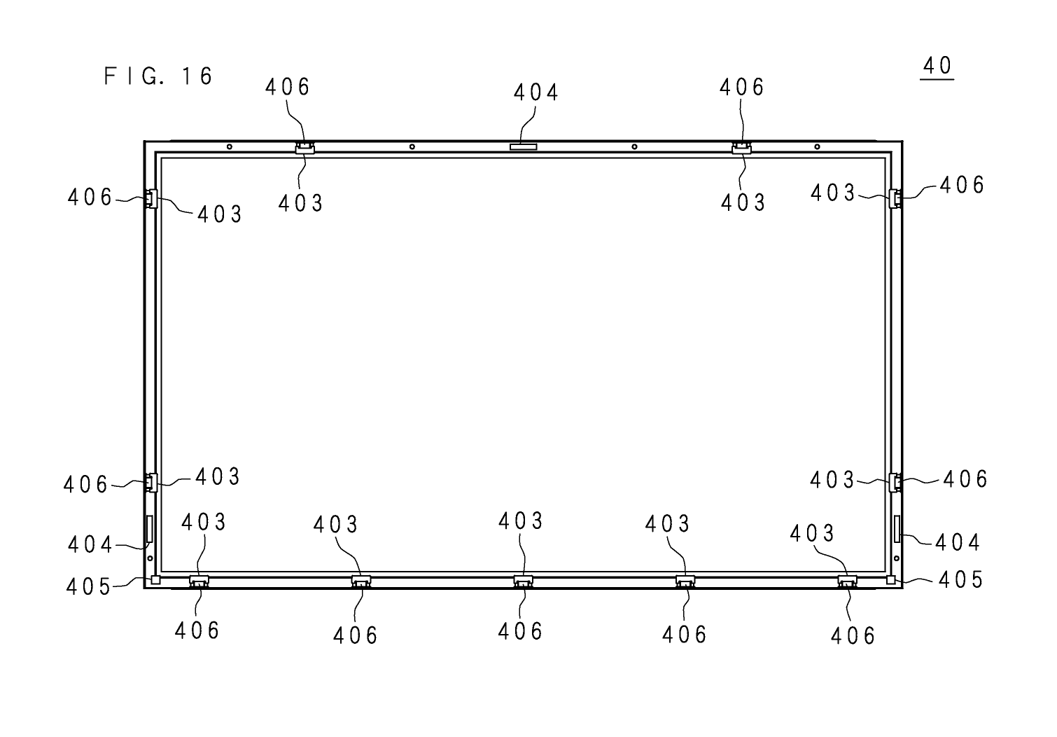

FIGS. 15A, 15B, 15C, 15D, 15E, 15F and 15G are views describing an assembling procedure of the liquid crystal television 1. FIGS. 15A to 15G are partial rear views of the liquid crystal television 1 in a state of during assembling, and illustrate a lower right portion of the liquid crystal television 1, respectively.

FIG. 15A is a partial rear view of the front cabinet 2. The front cabinet 2 is placed on the substantially horizontal plane while the back face of the front cabinet 2 is facing upward.

FIG. 15B illustrates the state in which the discharge prevention frame 40 is mounted on the front cabinet 2 in FIG. 15A. Herein, the discharge prevention frame 40 is mounted along the frame of the front cabinet 2.

Notches to be fitted with the first ribs 22 are provided at positions of the discharge prevention frame 40 corresponding to the first ribs 22. Apertures which are to be inserted into the second ribs 23 and the partition ribs 24 are provided at positions of the discharge prevention frame 40 respectively corresponding to the second ribs 23 and the partition ribs 24. When aligning the discharge prevention frame 40 on the front cabinet 2, the discharge prevention frame 40 is positioned with respect to the front cabinet 2 such that the first ribs 22, the second ribs 23 and the partition ribs 24 project upward from the notches and apertures thereof.

FIG. 15B also illustrates the state in which the heat sink 46, the LED substrate 47, the LED 48 and the connector 49 are mounted on the front cabinet 2 in FIG. 15A.

The LED 48 and the connector 49 are mounted on the LED substrate 47 in advance. The LED substrate 47 is fixed to the heat sink 46 by screws. Then, the heat sink 46 with the LED substrate 47 fixed thereto is mounted on the lower end of the discharge prevention frame 40.

FIG. 15C illustrates the state in which the liquid crystal panel 41 is mounted on the liquid crystal television 1 in FIG. 15B. The liquid crystal panel 41 is positioned so as to abut the inner surface of the plurality of first ribs 22 projecting upward from the peripheral edge of the opening 21, and the liquid crystal panel 41 is inserted into a space surrounded by the plurality of first ribs 22.

FIG. 15D illustrates the state in which the optical sheet 42 is mounted on the liquid crystal television 1 in FIG. 15C. The optical sheet 42 has a size large enough to abut the second ribs 23 with the outer peripheral edge thereof. However, when the optical sheet 42 is laminated on the liquid crystal panel 41, the first ribs 22 disposed inside from the second ribs 23 may overlap with the optical sheet 42. Therefore, the notches 421 are provided on the peripheral end part of the optical sheet 42 corresponding to the first ribs 22 so as to avoid the first ribs 22. Since the plurality of first ribs 22 are provided on the front cabinet 2, a plurality of notches 421 are provided on the optical sheet corresponding thereto. The optical sheet 42 is positioned so that the first ribs 22 are housed inside of the plurality of notches 421 respectively, and the peripheral end thereof abuts the inner surface of the plurality of second ribs 23, and then the optical sheet 42 is laminated on the liquid crystal panel 41.

FIG. 15E illustrates the state in which the light guide plate 43 is mounted on the liquid crystal television 1 in FIG. 15D. The light guide plate 43 is positioned so that three second ribs 23 provided on the front cabinet 2 are fitted with the recesses 431c of the light guide plate 43. At this time, the light guide plate 43 is also positioned so as to abut the recesses 431d of the lower corner of the light guide plate 43 with the two partition ribs 24 provided on the front cabinet 2. Then, the light guide plate 43 is inserted into a space surrounded by the second ribs 23 and the partition ribs 24.

FIG. 15F illustrates the state in which the backlight chassis 45 is mounted on the liquid crystal television 1 in FIG. 15E. The backlight chassis 45 is positioned so as to overlap screw insertion holes provided in the backlight chassis 45 with bosses provided on the front cabinet 2. Then, screws 5 are inserted into the screw insertion holes, and each component of the liquid crystal panel module 4 is fixed to the front cabinet 2 by the screws 5.

FIG. 15G illustrates the state in which the back cabinet 3 is mounted on the liquid crystal television 1 in FIG. 15F. The back cabinet 3 is positioned so as to provide internal contact between the periphery of the back cabinet 3 and the periphery of the front cabinet 2. At this time, the screw insertion holes provided in the back cabinet 3 are overlapped with the bosses provided on the front cabinet 2. Thereafter, screws 7 are inserted into the screw insertion holes and the back cabinet 3 and the front cabinet 2 are fixed by the screws 7.

The abutting ribs 31 which are provided on the front face of the back cabinet 3 abut the backlight chassis 45 of the liquid crystal panel module 4. Thereby, the abutting ribs 31 press the backlight chassis 45, and then the liquid crystal panel module 4, the back cabinet 3 and the front cabinet 2 are fixed by fastening the screws 7.

In the present embodiment, the plurality of the abutting ribs 31 are provided, but only one of abutting ribs 31 may be provided. The abutting ribs 31 may be arranged in three directions or more, and the abutting ribs 31 may not cross each other in different directions. For example, each of abutting ribs 31 may be disposed radially in six directions.

The liquid crystal television 1 according to the embodiment of the present invention has an edge light in which light of the LED 48 is made incident on only one side face of the light guide plate 43, and the heat sink 46, the LED substrate 47 and the LED 48 are provided only at positions facing the lower side face of the light guide plate 43.

However, in the edge light type liquid crystal television 1, for example, light may be made incident on all side faces of the light guide plate 43, or light may be made incident on left and right side faces or upper and lower side faces of the light guide plate 43. Therefore, the arrangement number and arrangement direction of the heat sink 46, the LED substrate 47 and the LED 48 may be changed depending on the number and the position of the side face of the light guide plate 43 on which the light is made incident.

The abutting ribs 31 of the back cabinet 3 according to the embodiment of the present invention abut the edge light type liquid crystal panel module 4. However, the abutting ribs 31 may abut a direct type liquid crystal panel module. That is, the liquid crystal television 1 may include a direct type backlight.

According to the liquid crystal television 1, it is possible to increase the strength of the liquid crystal panel module 4.

Conventionally, the strength of the liquid crystal panel module 4 excluding the bezel for fixing each component is lower than a liquid crystal panel module including a bezel. However, since abutting ribs 31 of the back cabinet 3 press the backlight chassis 45 by the fastening of the screws 7 for fixing the front cabinet 2 and the back cabinet 3, the strength of the liquid crystal panel module 4 is increased. Further, by providing the abutting ribs 31 on the back cabinet 3, the strength of the back cabinet 3 is also increased.

Since the back cabinet 3 made of a resin is lighter than the reinforcement material of the steel plate mounted on the backlight chassis 45, a reduction in the weight of the liquid crystal television 1 is not disturbed compared with the case of reinforcing the liquid crystal panel module with a reinforcing material. Further, since the abutting ribs 31 are provided by molding integrally with the back cabinet 3, it is possible to reduce the number of components similar to the case of excluding the bezel.

The back cabinet 3 abuts the backlight chassis 45 with the tip of the abutting ribs 31 in a line, that is, line contact rather than surface contact. Therefore, the contact area between the back cabinet 3 and the backlight chassis 45 is limited, and it is possible to inhibit chattering occurring by vibrations of the internal components.

Further, because the abutting ribs 31 are not in contact with the backlight chassis 45 in a surface shape, air is present between a region of the back cabinet 3 provided with the abutting ribs 31 and the backlight chassis 45. The air heated by the heat inside the liquid crystal television 1 is moved to the outside of the liquid crystal television 1 through the heat dissipation holes 34 of the back cabinet 3. Thereby, the heat dissipation effect is not deteriorated by the reinforcing structure with the abutting ribs 31.

According to the liquid crystal television 1, the uniformity of light in the screen 411 is not deteriorated.

Due to the fastening of the screws 5 and 7, a force pressing forward by the light guide plate 43 is applied to the tip end part of the first ribs 22, but it is not substantially applied to the optical sheet 42. Therefore, deformation such as bending, warpage, or the like does not occur in the optical sheet 42. Since the optical sheet 42 uniformly diffuses the light emitted from the light guide plate 43, and the diffused light is made incident on the liquid crystal panel 41, luminance unevenness in an image displayed on the screen 411 of the liquid crystal panel 41 can be prevented.

In order to increase the light incident rate into the light guide plate 43, the LED 48 and the light guide plate 43 are placed as close as possible to each other. However, when the side faces of the LED 48 and the light guide plate 43 vary even slightly from a predetermined distance, the luminance of the incident light changes significantly. Due to the change in luminance of the incident light onto the light guide plate 43, variations in the luminance of the light emitted from the light guide plate 43 may occur. Therefore, it is necessary that the distance between the LED 48 and the light guide plate 43 is not easily varied due to thermal deformation, vibration or the like.

According to the liquid crystal television 1, the thermal expansion of the light guide plate 43 is controlled by the second ribs 23 since the second ribs 23 are inserted in the recesses 431 of the light guide plate 43. The recesses 431 and the second ribs 23 are provided at a position corresponding to the LED 48 closer than substantially the center of the side face corresponding to the short side of the light guide plate 43. Therefore, the amount of movement of the portion of the light guide plate 43 on the lower side of the recesses 431, is always smaller than the amount of movement of the portion of the light guide plate 43 on the upper side of the recesses 431. Thus, it is possible to inhibit the variation in the distance between the LED 48 and the side face of the light guide plate 43 on which light is made incident.

### Embodiment 2

Embodiment 2 relates to a configuration in which a support part is provided on the discharge prevention frame (a frame body) 40 to support the light guide plate 43. The light guide plate 43 is sandwiched by the support part of the discharge prevention frame 40 located on the front and the backlight chassis 45 located on the back.

The discharge prevention frame 40 is a frame located between the front cabinet 2 on the front side and the liquid crystal panel 41 on the back side (see FIG. 2). The discharge prevention frame 40 has a size overlapping the plurality of first ribs 22, second ribs 23 and partition ribs 24 with each other, which are provided on the back side of the front cabinet 2 (see FIGS. 15A and 15B).

FIG. 16 is a rear view of the discharge prevention frame 40. The discharge prevention frame 40 is formed by pressing a metal material, for example. The discharge prevention frame 40 includes a cylindrical outer frame, and a flange-shaped inner frame protruding inwardly from the outer frame (see FIG. 2). The inner frame is substantially parallel to the front face of the light guide plate 43.

Rectangular-shaped first rib insertion holes (first insertion holes) 403 and second rib insertion holes (second insertion holes) 404, which are to have the first ribs 22 and the second ribs 23 inserted therein, are formed in the inner frame of the discharge prevention frame 40 at positions corresponding to the first ribs 22 and the second ribs 23. Further, rectangular-shaped partition rib insertion holes 405, which are to have the partition ribs 24 inserted therein, are provided on the inner frame of the discharge prevention frame 40, at positions corresponding to the partition ribs 24.

Bridges 406 are provided on the discharge prevention frame 40. The bridge 406 corresponds to the support part that supports the light guide plate 43. When facing the back side or the front side, the bridges 406 partially close a nearer outside region of the first rib insertion holes 403.

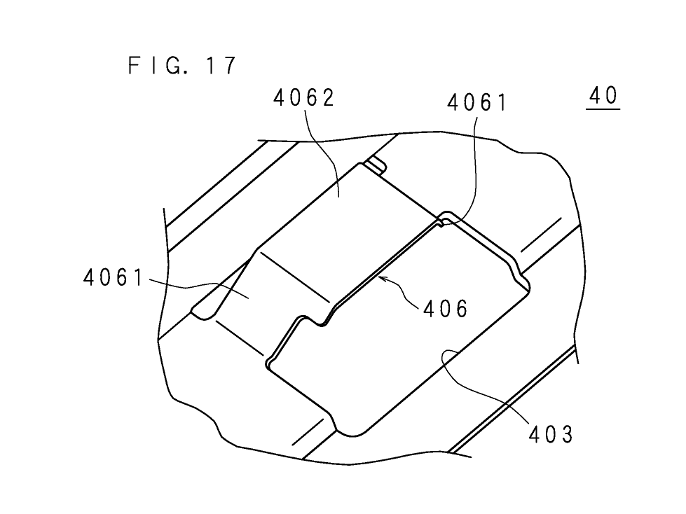

FIG. 17 is a partially enlarged perspective view illustrating the discharge prevention frame 40. FIG. 17 illustrates a portion of the first rib insertion hole 403 by enlarging. The lower right in FIG. 17 indicates the inside direction of the discharge prevention frame 40, and the upper left in FIG. 17 indicates the outside direction of the discharge prevention frame 40.

The bridge 406 includes two protrusion portions 4061 and a flat portion 4062. The two protrusion portions 4061 are plate-shape members respectively protruding from the peripheral edge parts facing each other to the back side in the circumferential direction of the discharge prevention frame 40 of the peripheral edge parts of the first rib insertion holes 403. In FIG. 17, the two protrusion portions 4061 protrude in a direction approaching each other from the peripheral edge parts of the first rib insertion holes 403 and in a direction toward the back side thereof. That is, the two protrusion portions 4061 respectively protrude from the inner peripheral parts of the first rib insertion holes 403 to the back side thereof at an acute angle with respect to the opening surface of the first rib insertion holes 403.

The flat portion 4062 is a flat plate which is bridged between the two protrusion portions 4061 in the circumferential direction of the discharge prevention frame 40. The flat portion 4062 is substantially parallel to the inner frame of the discharge prevention frame 40. Therefore, the flat portion 4062 is also substantially parallel with the front face of the light guide plate 43.

The bridge 406 is provided so as to close the nearer outside region of the first rib insertion holes 403, and the nearer inside region of the first rib insertion holes 403 remains open. When the discharge prevention frame 40 is mounted on the front cabinet 2, the first ribs 22 protrude from the nearer inside region of the first rib insertion holes 403 to the back side thereof.

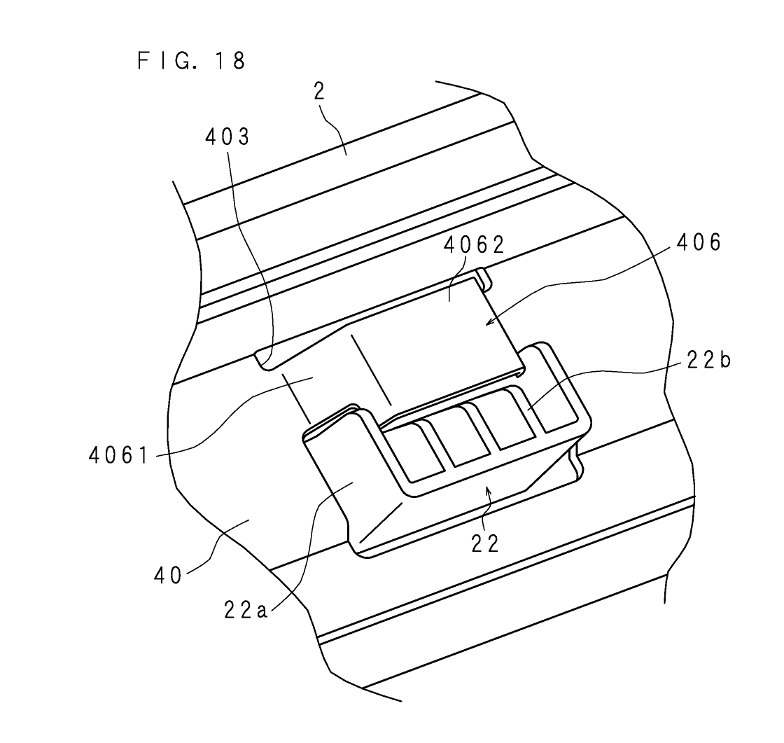

FIG. 18 is a partially enlarged perspective view illustrating the front cabinet 2 and the discharge prevention frame 40. FIG. 18 illustrates the first ribs 22, the first rib insertion holes 403 and the bridges 406 by enlarging, with the discharge prevention frame 40 being mounted on the front cabinet 2. The lower right in FIG. 18 indicates the inside direction of the front cabinet 2 and the discharge prevention frame 40, and the upper left in FIG. 18 indicates the outside direction of the discharge prevention frame 40 and the front cabinet 2.

When the liquid crystal panel module 4 is assembled, the height of the flat portion 4062 is higher than the height of the first rib 22 protruding from the first rib insertion hole 403 to the back side thereof. That is, the height of the flat portion 4062 and the height of the first ribs 22 are adjusted so that, when the liquid crystal panel module 4 is assembled, the flat portion 4062 abuts the front peripheral edge part of the light guide plate 43, while the tip end part of the first rib 22 does not abut the light guide plate 43.

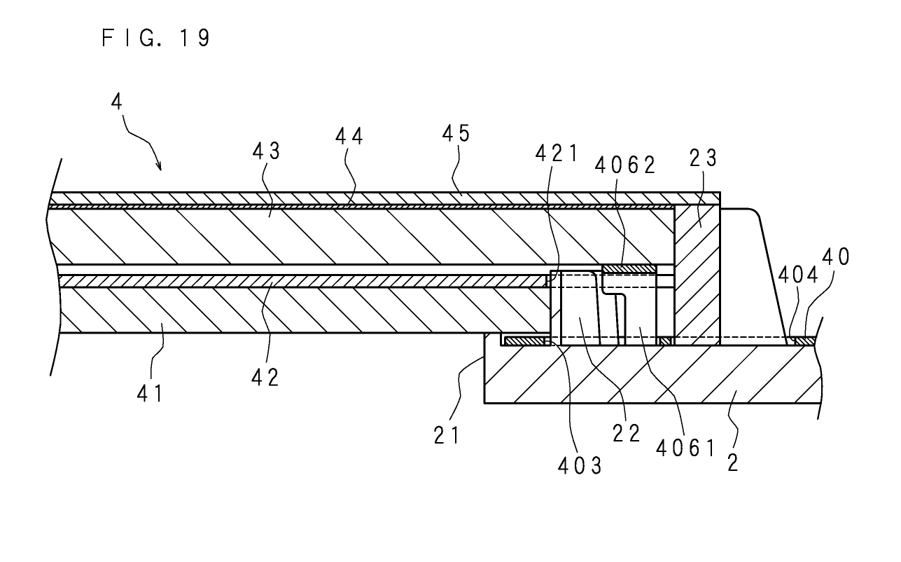

FIG. 19 is a view describing an outline of placing the component of the liquid crystal panel module 4 on the front cabinet 2. In FIG. 19, the left side corresponds to the inside of the front cabinet 2, and the left end of the front cabinet 2 is intercepted at the periphery of the opening 21. In FIG. 19, the right side corresponds to the outside of the front cabinet 2. FIG. 19 illustrates the outline of the discharge prevention frame 40, the liquid crystal panel 41, the optical sheet 42, the light guide plate 43 and the reflective sheet 44 which are laminated on the front cabinet 2 including the positional relationship with respect to the first ribs 22, the second ribs 23 and the bridges 406. In fact, the first rib 22 and the second rib 23 are isolated from each other, however, the first rib 22 and the second rib 23 in FIG. 19 are illustrated by protruding in a normal direction of FIG. 19, and are drawn close to each other.

An edge part of the front face of the liquid crystal panel 41 abuts the edge of the front cabinet 2 around the opening 21, and the side face of the liquid crystal panel 41 abuts the inner surface of the first ribs 22. The optical sheet 42 is laminated on the liquid crystal panel 41.

The edge part of the front face of the liquid crystal panel 41 may be supported by the discharge prevention frame 40 through the spacer 4a, as illustrated in FIG. 3, however this edge part may be supported only by the front cabinet 2 without providing the spacer 4a.

The notch 421 is provided on the peripheral end of the optical sheet 42 facing the first rib 22, and the notch 421 is spaced apart from the inner surface of the first rib 22 with a small gap. The peripheral end of the optical sheet 42 which is not provided with the notch 421 abuts the inner surface of the second rib 23. In FIG. 19, the solid line of the optical sheet 42 illustrates a peripheral end part of the optical sheet 42 facing the first rib 22 and the second rib 23. The broken line of the optical sheet 42 illustrates a hollow portion of the notch 421 avoiding the first rib insertion hole 403 and the bridge 406.

The height of the first rib 22 in Embodiment 2 is slightly lower than the height of the first rib 22 in Embodiment 1. When the liquid crystal panel module 4 is assembled, the height of the first rib 22 is slightly higher than the distance between the back face of the front cabinet 2 and the back face of the optical sheet 42. In other words, the height of the first rib 22 is greater than the total thickness of the discharge prevention frame 40, the liquid crystal panel 41 and the optical sheet 42. On the other hand, when the liquid crystal panel module 4 is assembled, the height of the flat portion 4062 of the bridge 406 is greater than the height of the first rib 22 protruding from the first rib insertion hole 403. Therefore, the front peripheral edge part of the light guide plate 43 in FIG. 19 abuts the flat portion 4062 of the bridge 406, and is not contact with the first rib 22.

Alternately, the height of the first rib 22 may be the same as the total thickness of the discharge prevention frame 40, the liquid crystal panel 41 and the optical sheet 42.

The side face of the light guide plate 43 in FIG. 19 abuts the inner surface of the second rib 23. The reflective sheet 44 is laminated on the light guide plate 43, and the peripheral edge of the reflective sheet 44 abuts the inner surface of the second rib 23. The back face of the reflective sheet 44 abuts the backlight chassis 45. The peripheral edge part of the front face of the backlight chassis 45 abuts the tip end face of the second rib 23. When fastening the screws 5, a pressing force is applied to the light guide plate 43 from the backlight chassis 45 through the reflective sheet 44, and thereby the flat portion 4062 of the bridges 406 is pressed.

The gap between the optical sheet 42 and the light guide plate 43 is illustrated by enlarging in FIG. 19. However, the gap is actually very narrow, even when the pressing force is applied to the light guide plate 43 by fastening the screws 5, the optical sheet 42 is not substantially pressed due to the narrow gap. Therefore, deformation such as bending, warpage, or the like due to the pressing does not occur in the optical sheet 42.

Further, the liquid crystal television 1 may include a conductive plate which is connected to a ground cable for reducing the electro-magnetic interference (EMI), instead of the discharge prevention frame 40. In this case, the conductive plate has the same shape as the discharge prevention frame 40, and is incorporated in the same position as the discharge prevention frame 40 in the liquid crystal television 1. In this case, the conductive plate is provided with a support part for supporting the light guide plate 43.

In Embodiment 2, the height of the bridge 406 in the rear direction is greater than the height of the first rib 22 which projects from the first rib insertion hole 403. However, the height of the bridge 406 in the rear direction may be the same as the height of the first rib 22 which projects from the first rib insertion hole 403. In this case, the flat portion 4062 of the bridges 406 and the tip end part of the first rib 22 abut the front face peripheral edge part of the light guide plate 43, and the front side of the light guide plate 43 is supported by both of the bridge 406 and the first rib 22.

In Embodiment 2, a total of two protrusion portions 4061 are provided on opposite peripheral edge parts in the first rib insertion holes 403 one by one. However, two or more protrusion portions 4061 may be provided on opposite peripheral edge parts in the first rib insertion holes 403. For example, a total of six protrusion portions 4061 may be provided on opposite peripheral edge parts in the first rib insertion holes 403 in threes, respectively. In this case, the flat portions 4062 are bridged between three protrusion portions 4061 on one side and three protrusion portions 4061 on the other side.

According to the liquid crystal television 1, the uniformity of light in the screen 411 is not deteriorated.

Due to the fastening of screw 5 and 7, a force pressing forward by the light guide plate 43 is applied to the flat portion 4062 of the bridge 406, but it is not substantially applied to the optical sheet 42. Therefore, deformation such as bending, warpage, or the like does not occur in the optical sheet 42. Since the optical sheet 42 uniformly diffuses the light emitted from the light guide plate 43, and the diffused light is incident to the liquid crystal panel 41, luminance unevenness in an image displayed on the screen 411 of the liquid crystal panel 41 can be prevented.

Embodiment 2 is configured as described above, and other configuration thereof is the same as that of Embodiment 1, therefore the corresponding components will be denoted by the same reference numerals as Embodiment 1, and a detailed description thereof will be omitted.

The liquid crystal display apparatus has been described as an example of a liquid crystal television 1. The liquid crystal display apparatus according to the present application may be applied to a monitor connected to and used with a personal computer, or server computer, etc., or an indoor display and street display used for digital signage.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

1-8. (canceled)

9. A liquid crystal display apparatus in which a liquid crystal panel module is disposed between a front cabinet on a front side and a back cabinet on a back side,
wherein the liquid crystal panel module includes a liquid crystal panel, an optical sheet, and a light guide plate, which are sequentially laminated from the front side to the back side, and
when light from a light source is made incident on the light guide plate and the light is outputted from the light guide plate to the optical sheet, an image is displayed on a screen of the liquid crystal panel viewed through an opening provided in the front cabinet, the liquid crystal display apparatus comprising:
a plurality of protrusions which are provided on a back face of the front cabinet around the opening; and
wherein the protrusions have a height greater than a total thickness of the liquid crystal panel and the optical sheet.

10. The liquid crystal display apparatus according to claim 9,
wherein the tip end part of the protrusion abuts a front peripheral edge part of the light guide plate.

11. The liquid crystal display apparatus according to claim 9, further comprising
a plurality of second protrusions which are provided on the back face of the front cabinet around the opening at a position further away from the opening than the protrusions,
wherein the second protrusions have a height greater than a total thickness of the liquid crystal panel, the optical sheet and the light guide plate.

12. The liquid crystal display apparatus according to claim 9,
wherein the protrusions are ribs.

13. A liquid crystal television comprising:
the display apparatus according to claim 9; and
a receiving unit which receives television broadcasts,
wherein the liquid crystal panel module is configured to display an image relating to television broadcasts received by the receiving unit on the screen of the liquid crystal panel.
